(19) United States
(12) Patent Application Publication
(10) Pub. No.: US 2026/0370034 A1
(43) Pub. Date: Nov. 19, 2026

(54) SOCKET ASSEMBLY AND ENERGY STORAGE SYSTEM

(71) Applicant: SHENZHEN HELLO TECH ENERGY CO., LTD, Shenzhen (CN)

(72) Inventors: Feiyan LUO, Shenzhen (CN); Gaosong SHEN, Shenzhen (CN)

(21) Appl. No.: 19/726,891

(22) Filed: Jun. 30, 2026

Related U.S. Application Data
(63) Continuation of application No. PCT/CN2026/091109, filed on Apr. 16, 2026.

(30) Foreign Application Priority Data
Sep. 26, 2025 (CN) 202511401422.4
Sep. 26, 2025 (CN) 202522088532.1
Mar. 26, 2026 (CN) 202610388550.8
Mar. 26, 2026 (CN) 202620392226.9

(51) Int. Cl. H02J 9/06; H01R 13/74; H02H 1/00; H02H 3/16; H02J 7/00

(52) U.S. Cl. CPC H02J 9/062; H01R 13/748; H02H 1/0007; H02H 3/16; H02J 7/865

(57) ABSTRACT

Provided are a socket assembly and an energy storage system. The socket assembly is configured to be connected to utility power and an energy storage power supply and to externally supply power. A utility power access terminal is connected to the utility power and electrically connected to a first connection terminal. The energy storage power supply is in a pluggable connection with the first connection terminal. A second connection terminal is in a pluggable connection with the energy storage power supply. An output terminal is electrically connected to the second connection terminal and supplies power to a load.

### CROSS-REFERENCE TO RELATED APPLICATION

This application is a continuation of International Application No. PCT/CN 2026/091109, filed on Apr. 16, 2026, which claims priority to and benefits of Chinese patent application Nos. 202511401422.4 and 202522088532.1, filed with China National Intellectual Property Administration on Sep. 26, 2025, and Chinese patent application Nos. 202610388550.8 and 202620392226.9, filed with China National Intellectual Property Administration on Mar. 26, 2026, the entire content of which is incorporated herein by reference.

### FIELD

The present disclosure relates to the field of energy storage technologies, and more particularly, to a socket assembly and an energy storage system.

### BACKGROUND

With the development of smart grid technology, traditional sockets, serving only as passive power interfaces, fail to guarantee the continuous operation of critical loads during utility power outages. In response to such demands, energy storage systems with backup power capabilities have emerged. Continuous power supply is realized through the cooperation of energy storage power supplies and socket assemblies under various scenarios of utility power outages. However, such solutions still have limitations in terms of structural integration and deployment convenience. Slave distribution boxes are usually required, which are bulky and require complex wiring connections and layouts, resulting in high mounting time and labor costs.

### SUMMARY

Embodiments of the present disclosure provide a socket assembly and an energy storage system.

The present disclosure provides a socket assembly. The socket assembly is configured to be connected to utility power and an energy storage power supply and to externally supply power. The socket assembly includes a utility power access terminal, a first connection terminal, a second connection terminal, and an output terminal. The utility power access terminal is connected to the utility power via an electric wire. The first connection terminal is electrically connected to the utility power access terminal. The energy storage power supply is in a pluggable connection with the first connection terminal to supply power to the energy storage power supply through the first connection terminal. The second connection terminal is in a pluggable connection with the energy storage power supply to receive electric energy from the energy storage power supply. The output terminal is electrically connected to the second connection terminal and supplies power to a load. The first connection terminal is disconnected from the output terminal; or when the energy storage power supply is connected to the second connection terminal, the first connection terminal is disconnected from the output terminal.

In some embodiments, the socket assembly further includes a housing provided with a connection portion. The housing is configured to be detachably mounted and fixed to an external main body through the connection portion.

In some embodiments, the socket assembly is detachably mounted in a power distribution network. The power distribution network includes a distribution box. The distribution box is provided with a plurality of branch switches. The utility power flows to the load via the plurality of branch switches. The socket assembly is mounted upstream or downstream of the plurality of branch switches.

In some embodiments, the first connection terminal and/or the second connection terminal is detachably connected to the housing.

In some embodiments, the housing has an accommodation cavity and includes a first opening and a second opening through which the accommodation cavity is in communication with an outside of the housing. The first opening is configured to allow the first connection terminal to be at least partially inserted into or removed from the accommodation cavity. The second opening is configured to allow the second connection terminal to be at least partially inserted into or removed from the accommodation cavity.

In some embodiments, the first connection terminal includes a first protection shell and a first connection portion disposed at an outer side wall of the first protection shell. The housing includes a first engagement portion disposed at an inner side wall of the first opening. The first connection portion is engageable with the first engagement portion to allow the first connection terminal to be detachably connected to the housing.

In some embodiments, the second connection terminal includes a second protection shell and a second connection portion disposed at an outer side wall of the second protection shell. The housing includes a second engagement portion disposed at an inner side wall of the second opening. The second connection portion is engageable with the second engagement portion to allow the second connection terminal to be detachably connected to the housing.

In some embodiments, the first connection portion protrudes relative to the first protection shell and is deformable to change its distance from the outer side wall of the first protection shell. The first engagement portion protrudes relative to the inner side wall of the first opening in a direction towards a center of the first opening. The first connection portion is engaged with the first engagement portion to connect the first connection terminal to the housing, or the first connection portion is deformed under force and disengaged from the first engagement portion to separate the first connection terminal from the housing.

In some embodiments, the first connection portion protrudes relative to the first protection shell in a direction away from the outer side wall of the first protection shell. The first engagement portion protrudes relative to the inner side wall of the first opening and is deformable to change its distance from the inner side wall of the first opening. The first connection portion is engaged with the first engagement portion to connect the first connection terminal to the housing, or the first engagement portion is deformed under force and disengaged from the first connection portion to separate the first connection terminal from the housing.

In some embodiments, the second connection portion protrudes relative to the second protection shell and is deformable to change its distance from the outer side wall of the second protection shell. The second engagement portion protrudes relative to the inner side wall of the second opening in a direction towards a center of the second opening. The second connection portion is engaged with the second engagement portion to connect the second connection terminal to the housing, or the second connection portion is deformed under force and disengaged from the second engagement portion to separate the second connection terminal from the housing.

In some embodiments, the second connection portion protrudes relative to the second protection shell in a direction away from the outer side wall of the second protection shell. The second engagement portion protrudes relative to the inner side wall of the second opening and is deformable to change its distance from the inner side wall of the second opening. The second connection portion is engaged with the second engagement portion to connect the second connection terminal to the housing, or the second engagement portion is deformed under force and disengaged from the second connection portion to separate the second connection terminal from the housing.

In some embodiments, the housing includes a first housing and a second housing. The first housing has a first opening and a second opening. The first connection terminal is detachably mounted in the first opening. The second connection terminal is detachably mounted in the second opening. The second housing is detachably coupled to the first housing. The second housing and the first housing jointly define an accommodation cavity.

In some embodiments, the utility power access terminal is disposed at an outer side wall of the housing and includes a grounding terminal, a live terminal, and a neutral terminal. The grounding terminal is configured to be connected to a protective earth line of the utility power. The live terminal is configured to be connected to a phase line of the utility power. The neutral terminal is configured to be connected to a neutral line of the utility power.

In some embodiments, the first connection terminal includes a first protection shell and a first power connection portion protruding relative to the first protection shell. The first power connection portion is configured to be electrically connected to the utility power, such that the utility power can supply power to the energy storage power supply. The second connection terminal includes a second protection shell and a second power connection portion protruding relative to the second protection shell. The second power connection portion is configured to be electrically connected to each of the first power connection portion and the output terminal, to enable the utility power or the energy storage power supply to supply power to the load through the output terminal.

In some embodiments, the socket assembly further includes an outer casing. The outer casing has a through hole and a receiving cavity. The housing is mounted in the receiving cavity. The through hole is configured to allow the phase line, the neutral line, and the protective earth line to extend into the receiving cavity and to be electrically connected to the live terminal, the output terminal, and the ground terminal, respectively.

In some embodiments, the outer casing includes a first outer casing and a second outer casing connected to the first outer casing. The second outer casing and the first outer casing jointly define the receiving cavity. In a second direction, the second outer casing includes two extension portions that are opposite to and spaced apart from each other. The two extension portions extend relative to the inner side wall of the second outer casing towards the receiving cavity. In the second direction, the housing includes two connection portions located at opposite sides of the housing. The connection portions protrude relative to the housing in the second direction. The connection portions are engaged with the extension portions to connect the housing to the outer casing.

In some embodiments, a path is disposed between the first connection terminal and the output terminal. A switch is disposed in the path, and configured to be opened when the energy storage power supply is connected to the second connection terminal.

In some embodiments, the socket assembly further includes a control device configured to obtain a connection state between the energy storage power supply and the second connection terminal. The control device is further configured to close the switch to conduct the path when the energy storage power supply is disconnected from the second connection terminal, and/or to open the switch to break the path when the energy storage power supply is connected to the second connection terminal.

In some embodiments, the switch is operable in response to the connection state between the energy storage power supply and the second connection terminal. The switch is configured to be closed to conduct the path when the energy storage power supply is disconnected from the second connection terminal, and the switch is configured to be opened to break the path when the energy storage power supply is connected to the second connection terminal.

In some embodiments, the energy storage power supply includes a triggering member. The switch is configured to be closed to conduct the path when the energy storage power supply is disconnected from the second connection terminal. The triggering member abuts against the switch to break the path when the energy storage power supply is connected to the second connection terminal.

In some embodiments, the socket assembly further includes a leakage protection circuit including a detection unit, a controller, and a connection switch. The detection unit is configured to collect current signals of a phase line and a neutral line of the output terminal in real time, the controller being electrically connected to the detection unit. The connection switch is disposed on each of the phase line and the neutral line of the output terminal. The controller is configured to control the connection switch to be opened in response to an abnormal signal collected by the detection unit.

In some embodiments, the detection unit is disposed between the output terminal and the second connection terminal. The detection unit is configured to collect current signals of a phase line and a neutral line between the second connection terminal and the load in real time. The controller is electrically connected to the detection unit and configured to, in response to the signal collected by the detection unit, control the connection switch to be closed when no electric leakage occurs at the load, and control the connection switch to be opened when electric leakage occurs at the load.

In some embodiments, the leakage current protection circuit further includes a power supply connected to the controller and the phase line and configured to supply power to the controller.

In some embodiments, the leakage current protection circuit further includes an analog circuit having a terminal connected to the phase line between the second connection terminal and the load and another terminal connected to the neutral line for verifying effectiveness of the control assembly.

In some embodiments, the analog circuit includes a resistor element and a circuit switch. A first terminal of the resistor element is connected to the neutral line, a second terminal of the resistor element is connected to a first terminal of the circuit switch, and a second terminal of the circuit switch is connected to the phase line. When the circuit switch is closed, a current flowing from the second connection terminal partially flows to the neutral line, to alter the current signal collected by the detection unit.

In some embodiments, one of the first connection terminal and the second connection terminal is configured as a wired connection port. The connection port is capable of being connected to the other one of the first connection terminal and the second connection terminal, to connect the first connection terminal to the second connection terminal.

In some embodiments, the socket assembly further includes a jumper wire configured to connect the first connection terminal to the second connection terminal.

In some embodiments, the socket assembly has a first connection mode and a second connection mode. In the first connection mode, the second connection terminal is in a pluggable electrical connection with the first connection terminal via the jumper wire. In the second connection mode, the socket assembly is connected to the energy storage power supply, the first connection terminal is electrically connected to a power input interface of the energy storage power supply, the second connection terminal is electrically connected to a power output interface of the energy storage power supply, the utility power supplies power to the load through the power input interface and the power output interface of the energy storage power supply, and the load is supplied with power by electric energy outputted by the energy storage power supply when the utility power fails.

In some embodiments, the first connection terminal includes a first protection shell and a connection terminal disposed in the first protection shell. The connection terminal is configured to be electrically connected to the energy storage power supply. An outer wall of the first protection shell and/or the connection terminal is non-conductive.

In some embodiments, the second connection terminal includes a second protection shell and a metal member. The second protection shell has a jack. The metal member is disposed corresponding to the jack.

In some embodiments, the first connection terminal and the second connection terminal are disposed in the housing. The housing has a first jack. The first connection terminal includes a metal member. The metal member is disposed corresponding to the first jack.

In some embodiments, the first connection terminal and the second connection terminal are disposed in the housing. The housing has a second jack. The second connection terminal includes a connection interface. The connection interface is disposed corresponding to the second jack.

In a second aspect, the present disclosure provides an energy storage system. The energy storage system includes an energy storage power supply and the socket assembly according to any one of the above-described embodiments. The energy storage power supply is electrically connected to each of the first connection terminal and the second connection terminal. The load is capable of being supplied with power by the utility power or the energy storage power supply through the socket assembly. The energy storage power supply is operable to supply power when the utility power is cut off.

In some embodiments, the energy storage power supply includes a power input interface configured to be electrically connected to the first connection terminal and a power output interface configured to be electrically connected to the second connection terminal.

In some embodiments, the energy storage system has a first operating mode and a second operating mode. In the first operating mode, when utility power is connected or in an off-peak price state, the utility power charges the energy storage power supply and/or supplies power to the load through the energy storage power supply, the second connection terminal, and the output terminal. In the second operating mode, when the utility power is disconnected, or in a non-off-peak price state, the energy storage power supply supplies power to the load through the second connection terminal and the output terminal.

In some embodiments, the energy storage power supply includes a first switch, a second switch, an inverter, and a battery module. The power input interface is connected to the power output interface sequentially via the first switch and the second switch. The inverter has an end connected between the first switch and the second switch and another end connected to the battery module. In the first operating mode, both the first switch and the second switch are closed, and the inverter is in a rectification mode, to enable the inverter to charge the battery module using the utility power. In the second operating mode, the first switch is opened, the second switch is closed, and the inverter is in an inverter mode, to enable the electric energy of the battery module to be outputted to the second connection terminal through the inverter.

In some embodiments, both the first switch and the second switch include a relay.

In some embodiments, the energy storage system has a third operating mode. In the third operating mode, in a case where the energy storage power supply is disconnected from each of the first connection terminal and the second connection terminal, the first connection terminal is connected to the second connection terminal through a jumper wire and the utility power is available, the utility power supplies power to the load through the socket assembly.

In some embodiments, the energy storage system includes a first connection line and a second connection line. The first connection line is provided with a first connector and a second connector at two ends of the first connection line, respectively. The first connector is configured to be in a plug-in connection with the first connection terminal, and the second connector is configured to be in a plug-in connection with the power input interface or the second connection terminal. The second connection line is provided with a third connector and a fourth connector at two ends of the second connection line, respectively. The third connector is configured to be in a plug-in connection with the second connection terminal, and the fourth connector is configured to be in a plug-in connection with the power output interface or the first connection terminal.

In the socket assembly and the energy storage system of the present disclosure, the utility power access terminal of the socket assembly is connected to the utility power via the electric wire. The first connection terminal is electrically connected to the utility power access terminal and may be in a pluggable connection with the energy storage power supply. The second connection terminal is electrically connected to the output terminal and may also be in a pluggable connection with the energy storage power supply. In this case, the load can be selectively supplied with power by the utility power or the energy storage power supply through an electrical connection with the output terminal, to achieve flexible electric energy allocation. Therefore, the socket assembly of the present disclosure only needs to be connected to the circuit through the utility power access terminal and the output terminal, respectively, without the need for complicated wiring connections and assembly of accessories (such as a slave distribution box), resulting in relatively low mounting time and labor costs as well as good economy and convenience.

Additional aspects and advantages of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic structural view of an energy storage system according to some embodiments of the present disclosure.

FIG. 2 is a schematic perspective assembly view of a socket assembly according to some embodiments of the present disclosure from a viewing angle.

FIG. 3 is a schematic perspective assembly view of the socket assembly shown in FIG. 2 from another viewing angle.

FIG. 4 is a schematic exploded perspective view of the socket assembly shown in FIG. 2.

FIG. 5 is a top view of the socket assembly shown in FIG. 2.

FIG. 6 is a schematic cross-sectional view of the socket assembly shown in FIG. 5 taken along line VI-VI.

FIG. 7 is a schematic cross-sectional view of the socket assembly shown in FIG. 5 taken along line VII-VII.

FIG. 8 is a schematic electrical connection view of an energy storage system according to some embodiments of the present disclosure.

FIG. 9 is a schematic perspective assembly view of a socket assembly according to other embodiments of the present disclosure.

FIG. 10 is a schematic electrical connection view of an energy storage system according to other embodiments of the present disclosure.

FIG. 11 is a schematic electrical connection view of an energy storage system according to still other embodiments of the present disclosure.

FIG. 12 is a schematic electrical connection view of an energy storage system according to further embodiments of the present disclosure.

FIG. 13 is a schematic electrical connection view of an energy storage system according to yet other embodiments of the present disclosure.

FIG. 14 is a schematic electrical connection view of an energy storage system according to some other embodiments of the present disclosure.

FIG. 15 shows two mounting positions of a socket assembly according to some embodiments of the present disclosure in a utility power supply circuit.

FIG. 16 is a schematic electrical connection view of an energy storage system according to yet other embodiments of the present disclosure.

### DETAILED DESCRIPTION OF THE EMBODIMENTS

To make the above-mentioned objects, features, and advantages of the present disclosure more obvious and comprehensive, a detailed description of specific embodiments of the present disclosure will be given below in conjunction with the accompanying drawings. In the following description, many specific details are provided to facilitate full understanding of the present disclosure. However, the present disclosure can be implemented in many other ways than those described herein, and similar improvements can be made by those skilled in the art without contradicting the intent of the present disclosure. Therefore, the present disclosure is not limited by specific embodiments disclosed below.

In the description of the present disclosure, it should be understood that the orientation or the position indicated by terms such as “center”, “length”, “over”, “below”, “front”, “rear”, “vertical”, “horizontal”, “top”, “bottom”, “inner”, and “outer” should be construed to refer to the orientation or the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “plurality” means at least two, such as two and three, unless otherwise specifically defined.

In the present disclosure, unless otherwise clearly specified and limited, terms such as “install”, “connect”, “connect to”, and the like should be understood in a broad sense. For example, it may be a fixed connection or a detachable connection or connection as one piece; mechanical connection or electrical connection; direct connection or indirect connection through an intermediate; internal communication of two components or the interaction relationship between two components, unless otherwise specifically defined. For those of ordinary skill in the art, the specific meaning of the above-mentioned terms in the present disclosure can be understood according to specific circumstances.

In the present disclosure, unless specified or limited otherwise, the first characteristic being “on” or “under” the second characteristic refers to the first characteristic may be in direct contact with the second characteristic. And, the first characteristic being “on”, “above”, “over” the second characteristic may refer to the first characteristic is right over the second characteristic or is diagonally above the second characteristic, or just refer to the horizontal height of the first characteristic is higher than the horizontal height of the second characteristic. The first characteristic being “below” or “under” the second characteristic may refer to the first characteristic is right below the second characteristic or is diagonally under the second characteristic, or just refer to the horizontal height of the first characteristic is lower than the horizontal height of the second characteristic.

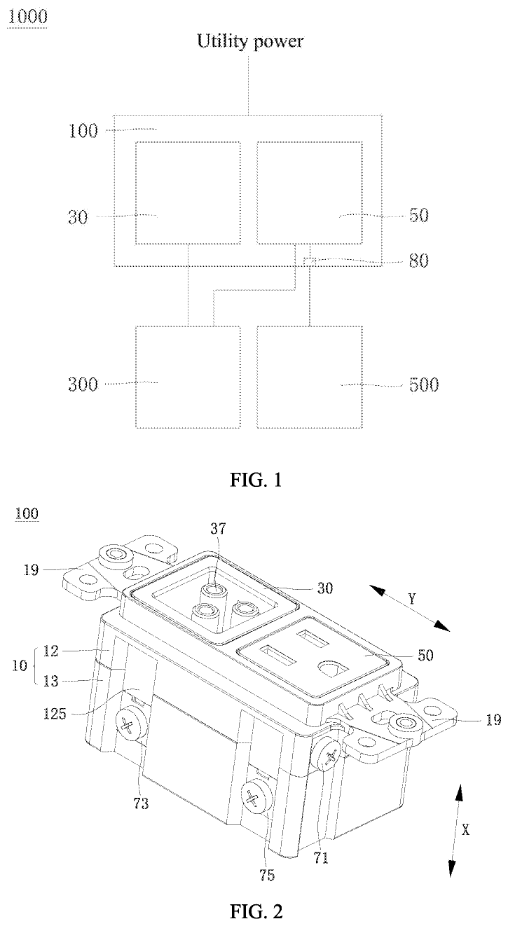

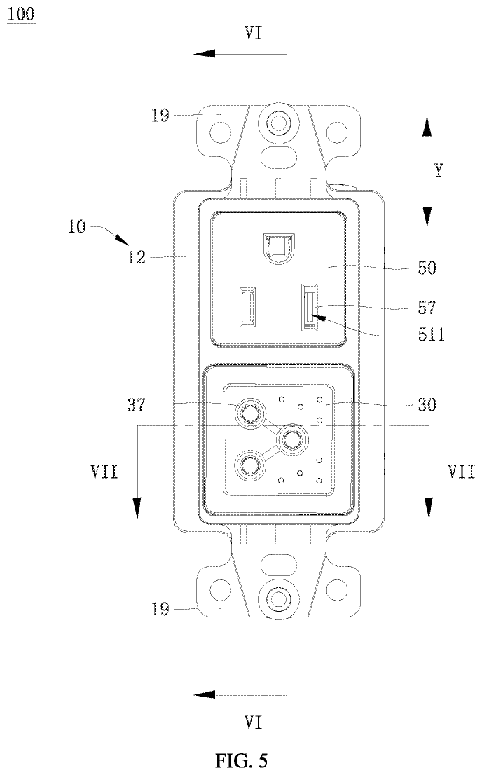

With the development of smart grid technology, traditional sockets, serving only as passive power interfaces, fail to guarantee the continuous operation of critical loads during utility power outages. In response to such demands, energy storage systems with backup power capabilities have emerged. Continuous power supply is realized through the cooperation of energy storage power supplies and socket assemblies under various scenarios of utility power outages. However, such solutions still have limitations in terms of structural integration and deployment convenience. Slave distribution boxes are usually required, which are bulky and require complex wiring connections and layouts, resulting in high mounting time and labor costs. To solve this problem, the present disclosure provides a socket assembly 100 (as illustrated in FIG. 2 to FIG. 9) and an energy storage system 1000 (as illustrated in FIG. 1).

As illustrated in FIG. 1 to FIG. 4, the present disclosure provides a socket assembly 100. The socket assembly 100 is configured to be connected to utility power and an energy storage power supply 300 and to supply power to an external load. The socket assembly 100 includes a housing 10, a utility power access terminal 70, a first connection terminal 30, a second connection terminal 50, and an output terminal 80. The housing 10 is provided with a connection portion 19. The housing 10 is configured to be detachably mounted and fixed to an external main body through the connection portion 19. The utility power access terminal 70 is connected to the utility power via an electric wire. The first connection terminal 30 is electrically connected to the utility power access terminal 70. The energy storage power supply 300 is in a pluggable connection with the first connection terminal 30 to supply power to the energy storage power supply 300 through the first connection terminal 30. The second connection terminal 50 is in a pluggable connection with the energy storage power supply 300 to receive electric energy from the energy storage power supply 300. The output terminal 80 is electrically connected to the second connection terminal 50 and supplies power to a load 500. The first connection terminal 30 is disconnected from the output terminal 80, or the first connection terminal 30 is disconnected from the output terminal 80 when the energy storage power supply 300 is connected to the second connection terminal 50.

In an exemplary embodiment of the present disclosure, in the utility power supply mode, the utility power is connected to the distribution box, which supplies power to loads through various power supply branches. A conventional power distribution network can only be supplied with power by the utility power. If the utility power fails, all the loads lose power. In this case, connection of a backup power source (such as an energy storage power supply) can solve a problem of load power loss after the utility power fails. Currently, there are mainly two solutions for connecting the backup power source.

One solution is to mount a smart slave distribution box on the basis of the original distribution box, or to directly replace the original distribution box with a slave distribution box. The slave distribution box can be connected to the utility power and the backup power source, and internally connected to a plurality of power supply branches. When the utility power fails, the slave distribution box automatically switches to power supply by the backup power source.

Another solution is that an Automatic Transfer Switch (ATS) is connected upstream of the distribution box. The ATS is connected to both the utility power and the backup power source, and can automatically switch to power supply by the backup power source after the utility power failure. It should be noted that a difference between the slave distribution box and the ATS is that the slave distribution box can internally form the plurality of power supply branches to supply power to the loads, while the ATS only has a function of switching between the utility power and the backup power source.

However, both of the above-described modification solutions have the following problems: (1) Both the slave distribution box and the ATS are large in size, occupying a relatively large space. Also, these two types of power facilities are expensive; (2) Professional electricians are required for mounting and hole drilling, resulting in high mounting costs. To address this problem, the present disclosure provides a socket assembly 100 featuring easy mounting and flexible power supply.

The socket assembly 100 is a device configured to realize electrical connections among the energy storage power supply 300, the utility power, and the load 500, as well as multi-port electric energy interaction. A core function of the socket assembly 100 is to configure a power flow direction and electrical parameters between ports based on a utility power state and user settings. In some embodiments, the socket assembly 100 can achieve flexible allocation of electric energy through predetermined control logic, featuring advantages of high integration and good practicality. In some embodiments, the socket assembly 100 is electrically connected to the energy storage power supply 300, and the energy storage power supply 300 can control the socket assembly 100 through the predetermined control logic, achieving the flexible allocation of the electric energy.

Exemplarily, in a household energy storage system, the socket assembly 100 may be a wall socket connected to the utility power. In this case, the load 500, such as a household appliance, can be supplied with power by the utility power, and can also be supplied with power by the energy storage power supply 300 when the utility power is disconnected. In mobile power consumption scenarios, such as recreational vehicles or outdoor operations, when connected to the utility power, the socket assembly 100 supplies power to the load 500 through built-in functional circuitry of the socket assembly 100 and charges the energy storage power supply 300 simultaneously. When the utility power is disconnected, the energy storage power supply 300 supplies power to the load 500, prolonging a usage duration of the load 500.

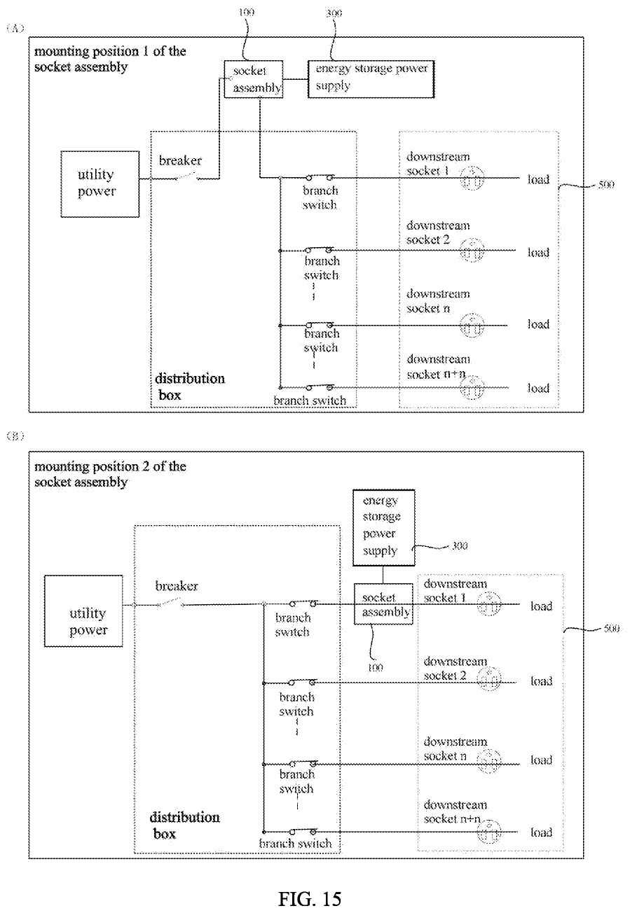

As illustrated in FIG. 1, FIG. 2, and FIG. 15, in some embodiments, the socket assembly 100 is detachably mounted in a power distribution network. The power distribution network includes a distribution box. The distribution box is provided with a plurality of branch switches. The utility power flows to the load 500 via the plurality of branch switches. The socket assembly 100 is mounted upstream or downstream of the plurality of branch switches.

In an exemplary embodiment of the present disclosure, the power distribution network is a network configured to achieve the allocation of the electric energy. The socket assembly 100 is detachably connected to the power distribution network to improve flexibility of a mounting process. It should be understood that when mounted in the power distribution network, the socket assembly 100 can be connected to the utility power through the utility power access terminal 70.

The distribution box is a complete set of electrical devices in the power distribution network and configured to receive electric energy supplied by an upstream power source and distribute the electric energy to a plurality of branch circuits. In some embodiments, the distribution box further has a protection function against faults such as overload and short circuit in lines and devices. As illustrated in FIG. 15, FIG. 15 shows specific mounting positions of the socket assembly 100 in a utility power supply circuit. The utility power serves as a source of the electric energy. The plurality of branch switches are disposed in the distribution box and configured to distribute and protect each of the plurality of branch circuits. The branch switch refers to a closing/opening control and protection element for each of the plurality of branch circuits in the distribution box, which is commonly implemented as a miniature circuit breaker or a fuse-type switch. The branch switch is configured to independently control a single power supply branch and automatically disconnect the circuit when an overcurrent or fault occurs in the branch, to ensure electrical safety and selective protection. The utility power flows to the load 500 at least through the branch switch to supply power to the load 500.

A wiring position of the socket assembly 100 may be selected as desired. As illustrated in (A) of FIG. 15, if the socket assembly 100 is disposed upstream of the branch switch, i.e., connected to a line side of each branch switch, the socket assembly 100 is not subject to the closing/opening control of the branch switch and is directly supplied with power by a main incoming line. In this case, if the socket assembly 100 is supplied with power by the energy storage power supply 300, it can supply power to the load 500 in each branch through the branch switch and is mainly applied to application scenarios where loads 500 on the plurality of branches are managed simultaneously. As illustrated in (B) of FIG. 15, if the socket assembly 100 is disposed downstream of the branch switch, i.e., connected to a load side of a branch switch, the socket assembly 100 is subjected to protection and controlling of the branch switch, shares the closed/opened state with the load 500 on the same branch, can supply power to the load 500, and is mainly applied to application scenarios where the load 500 on a single branch is selectively managed. This flexible wiring method can meet selection of power supply reliability or protection requirements in different scenarios. In this case, the socket assembly 100 has advantages of high flexibility and wide applicability.

The housing 10 is a structure in the socket assembly 100 configured to protect and mount other components besides the housing 10. The housing 10 is usually made of an insulation material to ensure the electrical safety. The housing 10 is made of, but not limited to, one or more combinations of plastic, a sheet material, and a carbon fiber composite material. For example, the housing 10 is made of plastic, which makes the socket assembly 100 lighter and less expensive.

The connection portion 19 is a structure disposed on the housing 10 and configured to achieve a detachable connection between the socket assembly 100 to the external main body. The connection portion 19 and the housing 10 may be integrally formed as one piece or formed as separate pieces. When the connection portion 19 and the housing 10 are formed as separate pieces, the connection portion 19 and the housing 10 are connected either detachably or non-detachably. The detachable connection includes, but is not limited to, one or more connections selected from a group consisting of a screw connection, a snap-fit connection, etc., as well as combinations thereof. The non-detachable connection includes, but is not limited to, one or more connections selected from a group consisting of adhesive bonding, welding, sintering, etc., as well as combinations thereof. This definition will be used for both the detachable connection and the non-detachable connection in the following descriptions, and thus details thereof will be omitted here.

The external main body may be a structure directly configured to mount the socket assembly 100 in the application scenario of the socket assembly 100, or may be an outer casing 90 (described below) configured to protect the housing 10. In this case, the housing 10 is indirectly mounted, through the outer casing 90, in the structure configured to mount the socket assembly 100 in the application scenario. The connection portion 19 and the external main body are connected detachably. In this case, the housing 10 can be stably mounted and fixed to the external main body and flexibly removed from the external main body for maintenance or relocation, resulting in good operating stability and flexibility of the socket assembly 100.

It should be understood that the utility power refers to alternating current electric energy generated by a power plant and transmitted to an end user through a power transmission and distribution system, and is characterized by a fixed frequency and voltage. Exemplarily, the standard in mainland China is 220 V, 50 Hz sinusoidal alternating current. It should be noted that the utility power is not limited to the standard used in mainland China, and may also refer to 120 V (a range from 110 V to 120 V), 60 Hz alternating current used in the United States and North America, 100 V, 50 Hz (eastern) or 60 Hz (western) alternating current used in Japan, 220 V, 60 Hz alternating current used in South Korea, etc.

The utility power access terminal 70 is a structure in the socket assembly 100 configured to be connected to the utility power. Serving as an auxiliary structure for utility power connection, the housing 10 can provide the socket assembly 100 with a stable and readily available power source. A high voltage is transmitted over a long distance by the utility power via a step-up transformer to reduce line loss and then stepwise distributed to a user terminal via a step-down transformer. For example, the utility power is connected to the utility power access terminal 70 of the socket assembly 100. The socket assembly 100 is mounted in buildings or applied in mobile power consumption scenarios to meet operation requirements of general electrical devices in residential, commercial, and industrial fields.

The first connection terminal 30 is an electrical accessory configured to be connected to the energy storage power supply 300 in the socket assembly 100, provides a pluggable power interface for the energy storage power supply 300, and is a fundamental component for safe transfer of electric energy. The first connection terminal 30 is connected to the utility power via an electrical connection with the utility power access terminal 70. In this case, the energy storage power supply 300 can be electrically connected to the first connection terminal 30, realizing electric energy interaction between the energy storage power supply 300 and the utility power, such as charging through the utility power or providing electric energy to the utility power grid during periods of high electricity prices (i.e., grid connection).

It should be noted that the first connection terminal 30 may be either a socket or a plug. When the first connection terminal 30 is the socket, the energy storage power supply 300 may include a plug adapted to the first connection terminal 30 and be electrically connected to the first connection terminal 30 via a configured plug. Alternatively, the energy storage power supply 300 may include a socket, and a connection cable with two plugs has an end electrically connected to the first connection terminal 30 and the other end electrically connected to the energy storage power supply 300, to achieve an electrical connection between the energy storage power supply 300 and the first connection terminal 30. When the first connection terminal 30 is the plug, the energy storage power supply 300 may include a socket adapted to the first connection terminal 30 and be electrically connected to the first connection terminal 30 via a configured socket. Alternatively, the energy storage power supply 300 may include a plug, and a connection structure with two sockets is electrically connected to the plug of the first connection terminal 30 and the plug of the energy storage power supply 300, to achieve the electrical connection between the energy storage power supply 300 and the first connection terminal 30. For convenience of description, the first connection terminal 30 being the socket and the energy storage power supply 300 including the plug adapted to the first connection terminal 30 are taken as an example for explanation below.

The second connection terminal 50 is an electrical accessory configured to be connected to the energy storage power supply 300 to receive electric energy from the energy storage power supply 300 in the socket assembly 100. It should be understood that the electric energy obtained by the second connection terminal 50 as well as the electric energy obtained by the output terminal 80 and the load 500 that are connected to downstream of the second connection terminal 50 may originate from multiple sources. For example, in a first approach, the electric energy is sourced from the utility power, which is transmitted through the first connection terminal 30 and then through a bypass of the energy storage power supply 300 to the second connection terminal 50. In a second approach, the electric energy source is sourced from electric energy stored in the energy storage power supply 300 itself. In a third approach, the electric energy source is sourced from the utility power transmitted through the first connection terminal 30 and then through the bypass of the energy storage power supply 300 to the second connection terminal 50, and the electric energy is also sourced from electric energy stored in the energy storage power supply 300 itself. In addition, the above three approaches for power supply pathways can be autonomously controlled by the energy storage power supply 300. In this case, an energy source of the load 500 becomes more flexible and diverse.

It should be noted that the energy storage power supply 300 has at least one of two operating modes: a grid-disconnected mode and a grid-connected mode. When the utility power is cut off, the energy storage power supply 300 is in the grid-disconnected mode. In this mode, an alternating current phase of the energy storage power supply 300 is inconsistent with that of the utility power. When the load 500 is supplied with power by the energy storage power supply 300 and the utility power, a large circulating current may exist, potentially damaging the load 300. In this case, the energy storage power supply 300 and the utility power fail to jointly supply power to the load 500. When the utility power is normal, the energy storage power supply 300 is in the grid-connected mode, and the alternating current phase of the energy storage power supply 300 is synchronized with that of the utility power. In this case, the energy storage power supply 300 and the utility power can jointly supply power to the load 500. The third approach described above corresponds to the power supply method in the grid-connected mode.

It should be noted that the second connection terminal 50 may be either a socket or a plug. When the second connection terminal 50 is the socket, the energy storage power supply 300 may include a plug adapted to the second connection terminal 50 and be electrically connected to the second connection terminal 50 through a configured plug. Alternatively, the energy storage power supply 300 may include a socket, and a connection cable provided with two plugs has an end electrically connected to the second connection terminal 50 and the other end electrically connected to the energy storage power supply 300, to achieve an electrical connection between the energy storage power supply 300 and the second connection terminal 50. When the second connection terminal 50 is the plug, the energy storage power supply 300 may include a socket adapted to the second connection terminal 50 and be electrically connected to the second connection terminal 50 through a configured socket. Alternatively, the energy storage power supply 300 may include a plug, and a connection structure provided with two sockets is electrically connected to the plug of the second connection terminal 50 and the plug of the energy storage power supply 300, to achieve the electrical connection between the energy storage power supply 300 and the second connection terminal 50. For convenience of description, the second connection terminal 50 being the socket and the energy storage power supply 300 including the plug adapted to the second connection terminal 50 are taken as an example for explanation below.

The output terminal 80 in the socket assembly 100 is an interface configured to output the electric energy to the load 500. The output terminal 80 is disposed in the housing 10 to ensure stability and reliability of an electric energy output process. The output terminal 80 is electrically connected to the second connection terminal 50 to obtain the electric energy provided by the energy storage power supply 300. In some embodiments, the energy storage power supply 300 can further enable an electrical connection between the first connection terminal 30 and the second connection terminal 50, to allow the utility power to supply power to the load 500 through the utility power access terminal 70 and the utility power output terminal 80. Two output terminals 80 are provided, one output terminal corresponding to the phase line and the other output terminal corresponding to the neutral line. In addition, the two output terminals 80 correspond to structures of the utility power access terminal 20 that are connected to the phase line and the neutral line, respectively, to form a reliable current path.

It should be noted that the load 500 refers to a device or a system capable of receiving and utilizing electric energy to operate or achieve a specific function. A core function of the load 500 is to convert the electric energy into other forms of energy (such as luminous energy, thermal energy, and mechanical energy). The load 500 herein is not limited to a power-consuming device that actually consumes the electric energy, and may also include a downstream socket that can assist in the implementation of a power consumption process and a power-consuming device connected thereto.

The power-consuming device may be, but is not limited to, a vehicle, a smart wearable device, a mobile terminal, a household appliance, and a medical device, which is not limited in the embodiments of the present disclosure. The vehicle includes, but is not limited to, a car, a bus, a train, a ship, an aircraft, etc. The smart wearable device includes, but is not limited to, a smart watch, a smart bracelet, a neck massager, etc. The mobile terminal includes, but is not limited to, a smart phone, a laptop computer, a tablet computer, and a point of sales terminal (POS) machine. The household appliance includes, but is not limited to, a television, a washing machine, an air conditioner, a rice cooker, a smart robotic sweeper, a smart light, etc. The medical device includes, but is not limited to, an infrared electronic thermometer, a pulse oximeter, a body composition analyzer, etc. It should be understood that the power-consuming device may be directly connected to the output terminal 80 to obtain the electric energy or obtain the electric energy through a connection between the downstream socket and the output terminal 80. For convenience of description, the power-consuming device (a load in a conventional sense), the downstream socket, and the power-consuming device connected thereto are collectively referred to as the load 500 below.

It should be understood that in this case, the utility power can be connected to each of the energy storage power supply 300 and the load 500 through the socket assembly 100, and selectively supply power to both the energy storage power supply 300 and the load 500. Exemplarily, when the utility power is connected or in an off-peak price state, the utility power can supply power to the energy storage power supply 300 and/or the load 500 through the socket assembly 100. When the utility power is disconnected or in a non-off-peak price state, the socket assembly 100 disconnects the power supply to the energy storage power supply 300, and the energy storage power supply 300 supplies power to the load 500 through the second connection terminal 50.

It should be noted that a disconnection state of the utility power includes two scenarios. In a first case, the utility power is actually cut off, and under a good contact condition, no electric energy is input from the utility power. In a second case, regardless of whether the utility power is actually available or cut off, no electric energy is input from the utility power due to poor contact or abnormal circuit function.

When the output terminal 80 supplies power to the load 500, for example, when the load 500 is supplied with power by the utility power and/or the energy storage power supply 300 through an electrical connection with the second connection terminal 50, the first connection terminal 30 is disconnected from the output terminal 80 to ensure the electrical safety.

Therefore, the load 500 has a rich and flexible source of electric energy, which can achieve continuous and reliable operation while reducing power consumption costs. More importantly, the connection process of the socket assembly 100 is simple. It only requires electrical connections of the utility power access terminal 70 and the output terminal 80. For example, in an application scenario where the socket assembly 100 is mounted in a building as a wall socket, it is only necessary to connect the mains input terminal 70 and the output terminal 80 to corresponding electric wires, respectively, without the need for complicated structures such as the slave distribution box. This design has advantages of easy and rapid mounting as well as convenient maintenance.

In the socket assembly 100 of the present disclosure, the utility power access terminal 70 of the socket assembly 100 is connected to the utility power supply via an electric wire. The first connection terminal 30 is electrically connected to the utility power access terminal 70 and may be in a pluggable connection with the energy storage power supply 300. The second connection terminal 50 is electrically connected to the output terminal 80 and may also be in a pluggable connection with the energy storage power supply 300. In this case, the load 500 can be optionally supplied with power by the utility power supply or the energy storage power supply 300 through the electrical connection with the output terminal 80, to achieve flexible allocation of the electric energy. Therefore, the socket assembly 100 of the present disclosure only needs to be connected to the circuits through the utility power access terminal 70 and the output terminal 80, respectively, without the need for complex wiring connections and assembly of accessories (such as the slave distribution box). Therefore, the mounting time and labor costs are low, resulting in good economy and convenience.

As illustrated in FIG. 2 to FIG. 4, in some embodiments, the first connection terminal 30 and/or the second connection terminal 50 are detachably connected to the housing 10. The housing 10 has an accommodation cavity 11 and includes a first opening 121 and a second opening 123 through which the accommodation cavity 11 is in communication with an outside of the housing 10. The first opening 121 is configured to allow the first connection terminal 30 to be at least partially inserted into or removed from the accommodation cavity 11. The second opening 123 is configured to allow the second connection terminal 50 to be at least partially inserted into or removed from the accommodation cavity 11.

In an exemplary embodiment of the present disclosure, when the first connection terminal 30 and the housing 10 are connected detachably, the first connection terminal 30 and the housing 10 can be flexibly disassembled and assembled, greatly improving convenience of maintenance, modification, or relocation processes. Similarly, it should be understood that for different energy storage power supplies 300, only the first connection terminal 30 needs to be replaced without replacing the entire socket assembly 100, making the socket assembly 100 more practical.

With the second connection terminal 50 and the housing 10 are connected detachably, the second connection terminal 50 and the housing 10 can be flexibly disassembled and assembled, greatly improving the convenience of maintenance, modification, or relocation processes. Similarly, it should be understood that for different energy storage power supplies 300, only the second connection terminal 50 needs to be replaced without replacing the entire socket assembly 100, making the socket assembly 100 more practical.

In addition, it should be noted that, due to flexible disassembly and assembly of the second connection terminal 50 and the housing 10, replacement of different types of the second connection terminals 50 achieves flexible power supply to different types of the loads 500 while the utility power and the energy storage power supply 300 remain unchanged. Taking the second connection terminal 50 being the socket as an example, socket types vary from country to country. For example, sockets in the US and Japan are the same, while European, Chinese, and British standard sockets differ from one another. In this case, when using different types of the loads 500 (the loads 500 with different plugs manufactured in different countries or regions), only the different second connection terminals 50 need to be replaced without replacing the entire socket assembly 100. That is, compatibility between different electrical standards is realized under fixed utility power, which allows a cross-border electrical appliance to operate normally, significantly improving practicality of the socket assembly 100.

The accommodation cavity 11 is a spatial structure enclosed by the housing 10 for accommodating at least part of functional components. The first opening 121 and the second opening 123 are spatial structures configured to enable communication between the accommodation cavity 11 and the outside of the housing 10. It should be understood that the first opening 121 and the second opening 123 are configured to improve convenience and smoothness of disassembling the first connection terminal 30 and the second connection terminal 50 from the housing 10. In this case, the first connection terminal 30 can be smoothly inserted, at least partially, into the accommodation cavity 11 through the first opening 121, or smoothly pulled out of the housing 10 through the first opening 121 when needed for replacement or maintenance. The second connection terminal 50 can be smoothly inserted, at least partially, into the accommodation cavity 11 through the second opening 123, or smoothly pulled out of the housing 10 through the second opening 123 when needed for replacement or maintenance. It should be noted that this insertion and removal can be performed manually or with the aid of tools.

Therefore, in the socket assembly 100 of the present disclosure, the first connection terminal 30 and the second connection terminal 50 can be smoothly and conveniently inserted into or removed from the accommodation cavity 11 through the first opening 121 and the second opening 123, respectively. The socket assembly 100 allows for flexible mounting, disassembly, or replacement of the first connection terminal 30 and the second connection terminal 50, greatly improving an efficiency of on-site mounting and subsequent maintenance, and exhibiting excellent flexibility. In addition, the second connection terminal 50 can adapt to different types of loads, making the socket assembly 100 highly practical.

As illustrated in FIG. 4 to FIG. 7, in some embodiments, the first connection terminal 30 includes a first protection shell 31 and a first connection portion 33 disposed at an outer side wall of the first protection shell 31. The housing 10 includes a first engagement portion 14 disposed at an inner side wall of the first opening 121. The first connection portion 33 is engageable with the first engagement portion 14 to allow the first connection terminal 30 to be detachably connected to the housing 10.

Therefore, in the socket assembly 100 of the present disclosure, the first connection terminal 30 is detachably connected to the housing 10 through engagement between the first connection portion 33 and the first engagement portion 14. Therefore, a connection between the first connection terminal 30 and the housing 10 is stable and reliable. The socket assembly 100 allows for flexible mounting, disassembly, or replacement of the first connection terminal 30, exhibiting good structural stability and reliability.

As illustrated in FIG. 4 to FIG. 6, in some embodiments, the second connection terminal 50 includes a second protection shell 51 and a second connection portion 53 disposed at an outer side wall of the second protection shell 51. The housing 10 includes a second engagement portion 15 disposed at an inner side wall of the second opening 123. The second connection portion 53 is engageable with the second engagement portion 15 to allow the second connection terminal 50 to be detachably connected to the housing 10.

Therefore, in the socket assembly 100 of the present disclosure, the second connection terminal 50 is detachably connected to the housing 10 through engagement between the second connection portion 53 and the second engagement portion 15. Therefore, a connection between the second connection terminal 50 and the housing 10 is stable and reliable. The socket assembly 100 allows for flexible mounting, disassembly, or replacement of the second connection terminal 50, exhibiting good structural stability and reliability.

As illustrated in FIG. 4 to FIG. 7, in some embodiments, the first connection portion 33 protrudes relative to the first protection shell 31 and is deformable to change its distance from the outer side wall of the first protection shell 31. The first engagement portion 14 protrudes relative to the inner side wall of the first opening 121 in a direction towards a center of the first opening 121. The first connection portion 33 is engaged with the first engagement portion 14 to connect the first connection terminal 30 to the housing 10, or the first connection portion 33 is deformed under force and disengaged from the first engagement portion 14 to separate the first connection terminal 30 from the housing 10.

For example, during insertion of the first connection terminal 30 into the housing 10 through the first opening 121 to achieve a connection between the first connection terminal 30 and the housing 10, the housing 10 and/or the first engagement portion 14 abut against the first connection portion 33 and force the first connection portion 33 to deform to move closer to the outer side wall of the first protection shell 31. After the first connection terminal 30 is inserted into place, force applied to the first connection portion 33 is released. The first connection portion 33 is deformed and moves away from the outer side wall of the first protection shell 31, in such a manner that the first connection portion 33 is engaged with the first engagement portion 14. In this case, the first connection terminal 30 is unable to move relative to the housing 10 in a direction away from the accommodation cavity 11.

During removal of the first connection terminal 30 from the housing 10 through the first opening 121 to disconnect the first connection terminal 30 from the housing 10, the first connection portion 33 is deformed under force and moves closer to the outer side wall of the first protection shell 31. In this case, the first engagement portion 14 do not abut against the first connection portion 33 during the movement of the first connection terminal 30 relative to the housing 10 in the direction away from the accommodation cavity 11. Therefore, the first connection terminal 30 is separated from the housing 10 and can be smoothly removed from the housing 10.

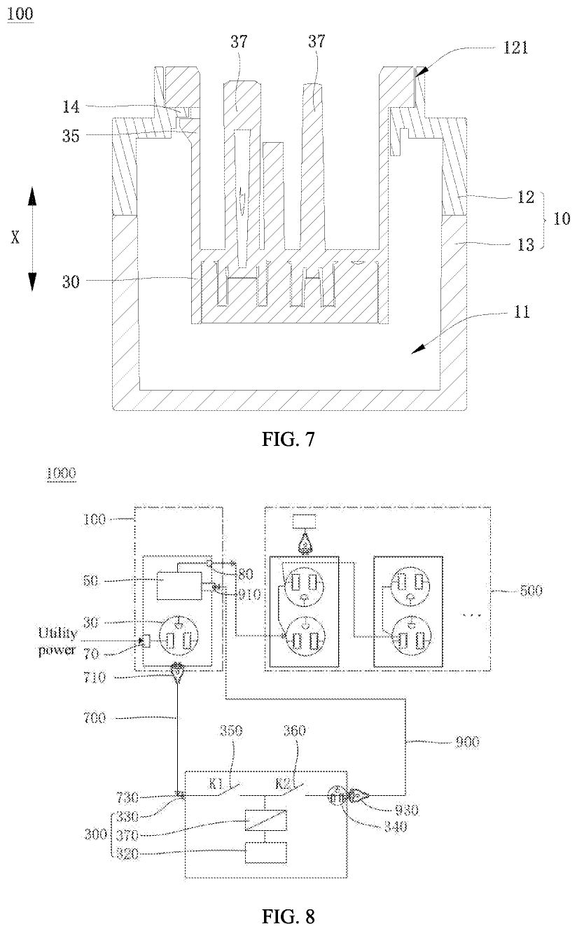

It should be noted that the movement of the first connection terminal 30 relative to the housing 10 in a direction towards the accommodation cavity 11 is also restricted. In some embodiments, as illustrated in FIG. 7, an edge of the first protection shell 31 abuts against the first engagement portion 14 to restrict the movement of the first connection terminal 30 relative to the housing 10 in the direction towards the accommodation cavity 11. In this case, the first engagement portion 14 is clamped from two opposite sides by the edge of the first protection shell 31 and the first connection portion 33, resulting in better connection stability between the first connection terminal 30 and the housing 10. In other embodiments, the housing 10 contains at least part of filler, which abuts against the first connection terminal 30 when the first connection portion 33 is engaged with the first engagement portion 14, to restrict the movement of the first connection terminal 30 relative to the housing 10 in the direction towards the accommodation cavity 11.

Therefore, in the socket assembly 100 of the present disclosure, the first connection portion 33 is deformable to be engaged with or disengaged from the first engagement portion 14, realizing the connection or separation between the first connection terminal 30 and the housing 10. A connection structure between the first connection terminal 30 and the housing 10 is simple and reliable, and a connection process is convenient and labor-saving, facilitating quick disassembly and mounting by an operator.

As illustrated in FIG. 4 to FIG. 7, in some embodiments, the first connection portion 33 protrudes relative to the first protection shell 31 in a direction away from the outer side wall of the first protection shell 31. The first engagement portion 14 protrudes relative to the inner side wall of the first opening 121 and is deformable to change its distance from the inner side wall of the first opening 121. The first connection portion 33 is engaged with the first engagement portion 14 to connect the first connection terminal 30 to the housing 10, or the first engagement portion 14 is deformed under force and disengaged from the first connection portion 33 to separate the first connection terminal 30 from the housing 10.

In an exemplary embodiment of the present disclosure, an engagement process between the first connection portion 33 and the first engagement portion 14 is referred to the above description, and thus details thereof will be omitted here. Therefore, in the socket assembly 100 of the present disclosure, the first engagement portion 14 is deformable to be engaged with or disengaged from the first connection portion 33, realizing the connection or separation between the first connection terminal 30 and the housing 10. The connection structure between the first connection terminal 30 and the housing 10 is simple and reliable, and the connection process is convenient and labor-saving, facilitating quick disassembly and mounting by the operator.

As illustrated in FIG. 4 to FIG. 6, in some embodiments, the second connection portion 53 protrudes relative to the second protection shell 51 and is deformable to change its distance from the outer side wall of the second protection shell 51. The second engagement portion 15 protrudes relative to the inner side wall of the second opening 123 in a direction towards a center of the second opening 123. The second connection portion 53 is engaged with the second engagement portion 15 to connect the second connection terminal 50 to the housing 10, or the second connection portion 53 is deformed under force and disengaged from the second engagement portion 15 to separate the second connection terminal 50 from the housing 10.

In an exemplary embodiment of the present disclosure, an engagement process between the second connection portion 53 and the second engagement portion 15 is referred to the above description, and thus details thereof will be omitted here. Therefore, in the socket assembly 100 of the present disclosure, the second connection portion 53 is deformable to be engaged with or disengaged from the second engagement portion 15, realizing the connection or separation between the second connection terminal 50 and the housing 10. The connection structure between the second connection terminal 50 and the housing 10 is simple and reliable, and the connection process is convenient and labor-saving, facilitating quick disassembly and mounting by the operator.

As illustrated in FIG. 4 to FIG. 6, in some embodiments, the second connection portion 53 protrudes relative to the second protection shell 51 in a direction away from the outer side wall of the second protection shell 51. The second engagement portion 15 protrudes relative to the inner side wall of the second opening 123 and is deformable to change a distance between the second engagement portion 15 and the inner side wall of the second opening 123. The second connection portion 53 is engaged with the second engagement portion 15 to connect the second connection terminal 50 to the housing 10, or the second engagement portion 15 is deformed under force and disengaged from the second connection portion 53 to separate the second connection terminal 50 from the housing 10.

In an exemplary embodiment of the present disclosure, the engagement process between the second connection portion 53 and the second engagement portion 15 is referred to the above description, and thus details thereof will be omitted here. Therefore, in the socket assembly 100 of the present disclosure, the second engagement portion 15 is deformable to be engaged with or disengaged from the second connection portion 53, realizing the connection or separation between the second connection terminal 50 and the housing 10. The connection structure between the second connection terminal 50 and the housing 10 is simple and reliable, and the connection process is convenient and labor-saving, facilitating quick disassembly and mounting by the operator.

As illustrated in FIG. 2 to FIG. 4, in some embodiments, the housing 10 includes a first housing 12 and a second housing 13. The first housing 12 has a first opening 121 and a second opening 123. The first connection terminal 30 is detachably mounted in the first opening 121, and a second connection terminal 50 is detachably mounted in the second opening 123. The second housing 13 is detachably coupled to the first housing 12. The second housing 13 and the first housing 12 jointly define an accommodation cavity 11.

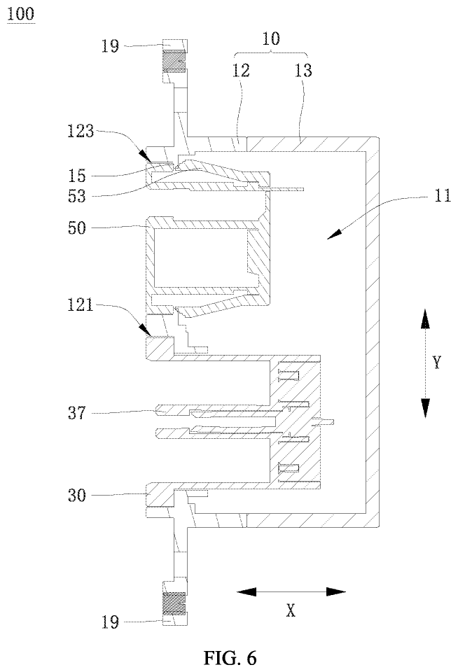

In an exemplary embodiment of the present disclosure, the first housing 12 is a partial structure in the housing 10 having the first opening 121 and the second opening 123, and the second housing 13 is a structure in the housing 10 configured to be engaged with the first housing 12 to jointly form the accommodation cavity 11. As illustrated in FIG. 6 and FIG. 7, it should be understood that a mechanical connection among the first connection terminal 30, the second connection terminal 50, and the housing 10 is mainly a connection among the first connection terminal 30, the second connection terminal 50, and the first housing 12. More specifically, the first connection terminal 30 is detachably mounted in the first opening 121 to realize a detachable connection between the first connection terminal 30 and the first housing 12, and the second connection terminal 50 is detachably mounted in the second opening 123 to realize a detachable connection between the second connection terminal 50 and the first housing 12.

When the second housing 13 and the first housing 12 are connected detachably, the second housing 13 can be easily separated from the first housing 12. In this case, the housing 10 is easily disassembled, facilitating internal maintenance. This is especially useful in a situation where operations are required to be performed on the first connection terminal 30 and/or the second connection terminal 50 from multiple orientations when jamming occurs between the first housing 12 and the first connection terminal 30 and/or the second connection terminal 50. In this case, disconnecting the first housing 12 from the second housing 13 can fully expose the first connection terminal 30 and/or the second connection terminal 50, to facilitate maintenance and repair.

Therefore, the socket assembly 100 of the present disclosure has advantages of simple structure, easy disassembly, maintenance and repair, and long service life without the need for frequent overall replacement, reducing usage costs of a user.

As illustrated in FIG. 2 to FIG. 4, in some embodiments, the utility power access terminal 70 is disposed at an outer side wall of the housing 10. The utility power access terminal 70 includes a grounding terminal 71, a live terminal 73, and a neutral terminal 75. The grounding terminal 71 is configured to be connected to a protective earth line of the utility power. The live terminal 73 is configured to be connected to a phase line of the utility power. The neutral terminal 75 is configured to be connected to a neutral line of the utility power.

In an exemplary embodiment of the present disclosure, the utility power access terminal 70 is disposed at the outer side wall of the housing 10. For example, the utility power access terminal 70 is mounted in an aperture formed at the first housing 12 and/or the second housing 13, in such a manner that the utility power access terminal 70 penetrates the housing 10 or is disposed only outside the housing 10.

The grounding terminal 71 is a structure configured to be connected to the protective earth line of the utility power. The grounding terminal 71 can achieve an electrical connection between the protective earth line and a protective grounding socket contact (not shown) in the socket assembly 100. The protective grounding socket contact is engaged with a grounding pin (not shown) on the plug of the energy storage power supply 300, forming a safe path for discharging leakage current.

The live terminal 73 is a structure configured to be connected to the phase line of the utility power. The live terminal 73 can achieve an electrical connection between the phase line and a phase line socket contact (not shown) in the socket assembly 100. The phase line socket contact is engaged with a phase line pin (not shown) on the plug of a negative energy storage power supply 300, to form an input terminal of the utility power.

The neutral terminal 75 is a structure configured to be connected to the neutral line of the utility power. The neutral terminal 75 can achieve an electrical connection between the neutral line and a neutral line socket contact (not shown) in the socket assembly 100. The neutral line socket contact is engaged with a neutral line pin (not shown) on the plug of the energy storage power supply 300, to form a return terminal of a current loop.

Exemplarily, the grounding terminal 71, the live terminal 73, and the neutral terminal 75 are usually made of materials with excellent electrical conductivity, such as copper alloy, to combine high electrical conductivity and mechanical strength. An electrical connection terminal usually includes a binding post, a clamping screw, or a quick-connect spring mechanism to achieve a reliable electrical connection between the wire and the socket contact through compression or elastic clamping. The grounding terminal 71 typically has a priority conduction structure (a pre-conduction structure) to realize make-before-break and guarantee the electrical safety.

In some embodiments, the socket assembly 100 further includes a mainboard configured to implement at least part of control processes. The utility power access terminal 70 further includes connection terminals disposed on the mainboard and configured to be electrically connected to the grounding terminal 71, the live terminal 73, and the neutral terminal 75. Through the respective connection terminals, the grounding terminal 71 is electrically connected to the protective grounding socket contact in the socket assembly 100, the live terminal 73 is electrically connected to the phase line socket contact in the socket assembly 100, and the neutral terminal 75 is electrically connected to the neutral line socket contact on the plug of the energy storage power supply 300.

Therefore, in the socket assembly 100 of the present disclosure, the protective earth line, the phase line, and the neutral line are connected to the grounding terminal 71, the live terminal 73, and the neutral terminal 75, respectively, to achieve a stable and reliable electrical connection between the utility power and functional structures inside the socket assembly 100. The socket assembly 100 can meet requirements of electrical safety and long-term operation.

As illustrated in FIG. 2 to FIG. 4, in some embodiments, one of the first housing 12 and the second housing 13 is provided with an insertion tab 125, and the other one of the first housing 12 and the second housing 13 has an insertion slot 127. In a first direction X along which the first housing 12 and the second housing 13 are coupled, the insertion tab 125 is opposite to and in a plug-in connection with the insertion slot 127 to connect the first housing 12 to the second housing 13.

In an exemplary embodiment of the present disclosure, to simplify descriptions, the following description is based on a configuration where the insertion tab 125 is disposed at the first housing 12 and the second housing 13 has the insertion slot 127. An embodiment where the insertion tab 125 is disposed at the second housing 13 and the first housing 12 has the insertion slot 127 is similar, and thus details thereof will be omitted here.

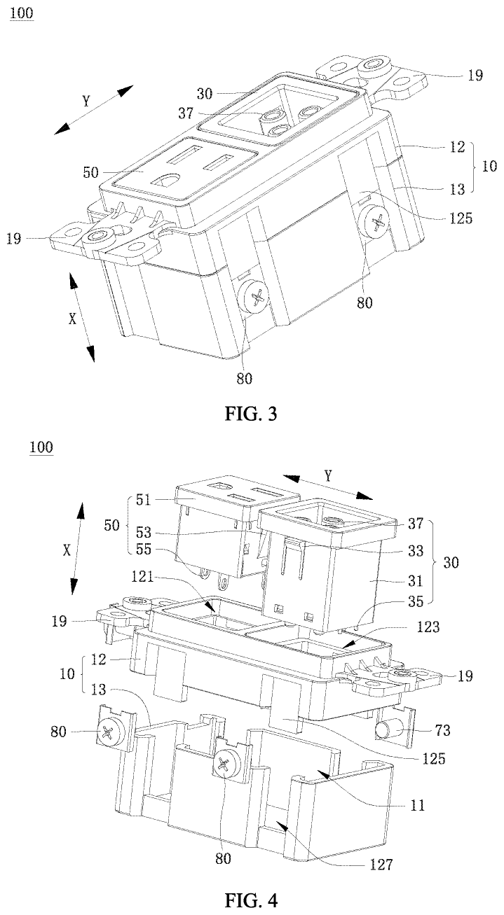

As illustrated in FIG. 3, the insertion tab 125 is a structure on the first housing 12 that protrudes relative to a main body of the first housing 12, and the insertion slot 127 is a spatial structure on the second housing 13 configured to accommodate the insertion tab 125 and form a plug-in connection therewith. It should be understood that a dimension and shape of the insertion tab 125 are matched with a dimension and shape of the insertion slot 127 to ensure a stable plug-in connection between the insertion tab 125 and the insertion slot 127. The insertion tab 125 is usually in an interference fit with the insertion slot 127 to guarantee connection stability.

As illustrated in FIG. 2 to FIG. 4, a direction in which the first housing 12 and the second housing 13 are coupled is defined as the first direction X in the present disclosure. In the first direction X, the insertion tab 125 and the insertion slot 127 are at least partially opposite to each other in terms of space, and the insertion tab 125 can be in a plug-in connection with the insertion slot 127 when the first housing 12 and the second housing 13 are close to each other, achieving the connection between the first housing 12 and the second housing 13. In some embodiments, the connection stability between the first housing 12 and the second housing 13 can be further improved by applying insulation tape at a joint where the first housing 12 and the second housing 13 are connected.

As illustrated in FIG. 4 and FIG. 8, in some embodiments, the first connection terminal 30 includes a first protection shell 31 and a first power connection portion 35 protruding relative to the first protection shell 31. The first power connection portion 35 is configured to be electrically connected to the utility power, such that the utility power can supply power to the energy storage power supply 300. The second connection terminal 50 includes a second protection shell 51 and a second power connection portion 55 protruding relative to the second protection shell 51. The second power connection portion 55 is configured to be electrically connected to each of the first power connection portion 35 and the output terminal 80, to enable the utility power or the energy storage power supply 300 to supply power to the load 500 through the output terminal 80.

In an exemplary embodiment of the present disclosure, in the above-described embodiments, it should be noted that specific structures and properties of the first protection shell 31 and the second protection shell 51 in this embodiment are identical to those of the first protection shell 31 and the second protection shell 51 in the embodiments described above, and repeated description thereof will be omitted herein.

The first power connection portion 35 is a structure disposed in the first connection terminal 30 and configured to be electrically connected to the utility power. The first power connection portion 35 protrudes relative to the first protection shell 31, in such a manner that the first connection terminal 30, when mounted in the housing 10, is connected to a structure in the housing 10 configured for an electrical connection (such as a terminal and a metal contact). In this case, the utility power achieves a stable and reliable electrical connection with the energy storage power supply 300 through the first power connection portion 35. That is, the utility power can supply power to the energy storage power supply 300 through the first connection terminal 30, such as charging the energy storage power supply 300, or supplying power to the load 500 via the energy storage power supply 300, the second connection terminal 50, and the output terminal 80.

In some embodiments, the first connection terminal 30 is plug-and-play. That is, when the first connection terminal 30 is mounted in the housing 10, the first power connection portion 35 has a certain mechanical connection relationship with the structure inside the housing 10 configured for the electrical connection, to stably achieve an immediate electrical connection. In other embodiments, when the first connection terminal 30 is mounted in the housing 10, the electrical connection between the first power connection portion 35 and the structure inside the housing 10 configured for the electrical connection needs to be achieved through welding or other methods to ensure electrical safety and reliability of the electrical connection.

The second power connection portion 55 is a structure disposed in the second connection terminal 50 and configured to be electrically connected to each of the first power connection portion 35 and the output terminal 80. The second power connection portion 55 protrudes relative to the second protection shell 51, in such a manner that the second connection terminal 50, when mounted in the housing 10, can be connected to the structure inside the housing 10 configured for the electrical connection (such as the terminal and the metal contact.). In this case, the first power connection portion 35 achieves a stable and reliable electrical connection with the load 500 through the second power connection portion 55 and the output terminal 80. That is, the utility power can supply power to the load 500 through the first connection terminal 30 and the second connection terminal 50. Alternatively, the energy storage power supply 300 achieves the stable and reliable electrical connection with the load 500 through the second power connection portion 55. That is, the energy storage power supply 300 can supply power to the load 500 through the second connection terminal 50.

In some embodiments, the second connection terminal 50 is plug-and-play. That is, when the second connection terminal 50 is mounted in the housing 10, the second power connection portion 55 has a certain mechanical connection relationship with the structure inside the housing 10 configured for the electrical connection, to stably achieve the immediate electrical connection. In other embodiments, when the second connection terminal 50 is mounted in the housing 10, the electrical connection between the second power connection portion 55 and the structure inside the housing 10 configured for the electrical connection also needs to be achieved through welding or other methods to ensure the electrical safety and the reliability of the electrical connection.

It should be understood that the socket assembly 100 or a combination of the socket assembly 100 and the energy storage power supply 300 is provided with a functional circuit configured to control current directions of the utility power, the load 500, and the energy storage power supply 300, to reasonably regulate an electrical connection state of the socket assembly 100, realizing a predetermined flexible power supply function. The electrical connection state of the socket assembly 100 during operation is briefly described below with reference to FIG. 8. K1 and K2 are two switches and controlled by a predetermined control program.

As illustrated in FIG. 8, when K1 and K2 are closed, the utility power is electrically connected to the first power connection portion 35. While the utility power can supply power to the energy storage power supply 300, the second power connection portion 55 can be electrically connected to the first power connection portion 35 via K1 and K2, and the utility power can supply power to the load 500 through the output terminal 80. When K1 is open and K2 is closed, the utility power is electrically disconnected from the energy storage power supply 300, the first power connection portion 35 is electrically disconnected from the second power connection portion 55, and the energy storage power supply 300 supplies power to the load 500 through the second power connection portion 55 and the output terminal 80.

Therefore, in the socket assembly 100 of the present disclosure, the first connection terminal 30 is electrically connected to the utility power through the first power connection portion 35, and the second connection terminal 50 is optionally electrically connected to or disconnected from the first power connection portion 35 through the second power connection portion 55 as well as maintains an electrically connection with the output terminal 80, to achieve flexible power supply from the utility power to the energy storage power supply 300 and the load 500. The socket assembly 100 can flexibly control an electric energy interaction process, improve power consumption flexibility, and is particularly beneficial for ensuring long-term stable operation of the load 500 and reducing power consumption costs.

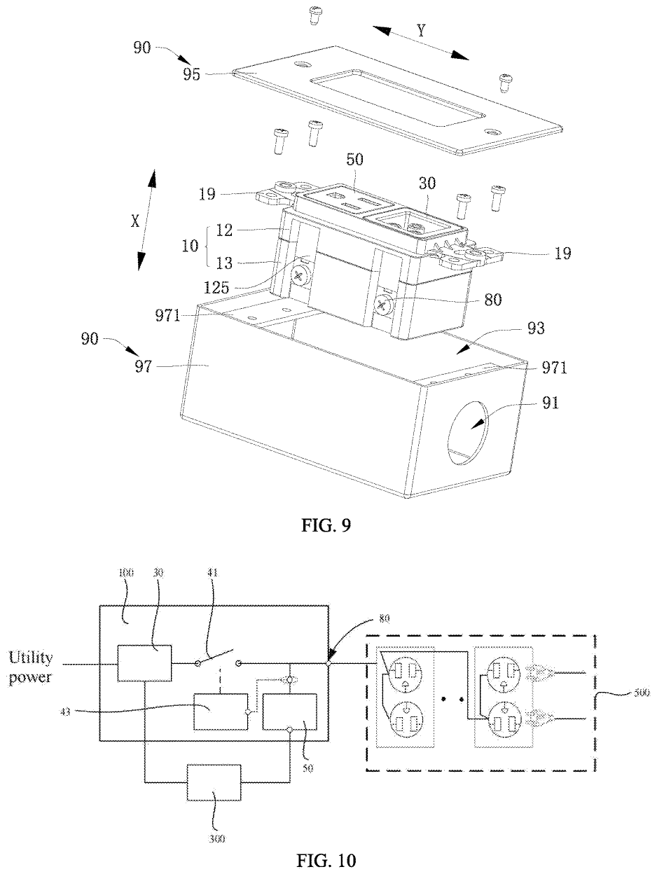

As illustrated in FIG. 3, FIG. 4, and FIG. 9, in some embodiments, the socket assembly 100 further includes an outer casing 90. The outer casing 90 has a through hole 91 and a receiving cavity 93. The housing 10 is mounted in the receiving cavity 93. The through hole 91 is configured to allow the phase line, the neutral line, and the protective earth line to extend into the receiving cavity 93 and to be electrically connected to the live terminal 73, the neutral terminal 75, and the grounding terminal 71, respectively.

In an exemplary embodiment of the present disclosure, the outer casing 90 is a structure in the socket assembly 100 configured to protect and mount other components besides the outer casing 90. The outer casing 90 is usually made of an insulation material to ensure the electrical safety. The outer casing 90 is made of, but not limited to, one or more material selected from a group consisting of plastic, a sheet material, and a carbon fiber composite material, as well as combinations thereof. The outer casing 90 is usually mounted at a predetermined position of the socket assembly 100. Exemplarily, when the socket assembly 100 is mounted in a fixed-position structure such as a wall, the outer casing 90 is made of plastic. In this way, the outer casing 90 can possess good electrical insulation performance, corrosion and rust resistance, compatibility with concrete or humid surroundings, as well as advantages of easy cutting and machining for improved construction efficiency.

It should be noted that the outer casing 90 may also be a user-configured structure.

The receiving cavity 93 is a spatial structure enclosed by the outer casing 90 for accommodating other functional components. The housing 10 is mounted in the receiving cavity 93, and the outer casing 90 protects the housing 10. The through hole 91 is a spatial structure on the outer casing 90 configured to achieve communication between an interior and an exterior of the outer casing 90. A dimension of the through hole 91 is usually set to be greater than a sum of cross-sectional areas of the phase line, the neutral line, and the protective earth line, in such a manner that the phase line, the neutral line, and the protective earth line can smoothly extend into the receiving cavity 93 through the through hole 91 and have sufficient layout space relative to the through hole 91. In this case, an end of the phase line, an end of the neutral line, and an end of the protective earth line are respectively electrically connected to the live terminal 73, the neutral terminal 75, and the grounding terminal 71 in the receiving cavity 93, to achieve electrical connections among the utility power, the first connection terminal 30, and the second connection terminal 50.

Therefore, in the socket assembly 100 of the present disclosure, the outer casing 90 is configured to mount and accommodate the housing 10, to allow the socket assembly 100 to have good structural stability. The phase line, the neutral line, and the protective earth line extend into the receiving cavity 93 through the through hole 91 and are electrically connected to the live terminal 73, the neutral terminal 75, and the grounding terminal 71, respectively, in such a manner that the socket assembly 100 has good electrical connection stability. In this case, the socket assembly 100 can stably achieve long-term electric energy interaction among the utility power, the energy storage power supply 300, and the load 500.

As illustrated in FIG. 3, FIG. 4, and FIG. 9, in some embodiments, the outer casing 90 includes a first outer casing 95 and a second outer casing 97 connected to the first outer casing 95. The first outer casing 95 and the second outer casing 97 jointly define the receiving cavity 93. In a second direction Y, the second outer casing 97 includes two extension portions 971 that are opposite to and spaced apart from each other. The two extension portions 971 extend relative to the inner side wall of the second outer casing 97 towards the receiving cavity 93. In the second direction Y, the housing 10 includes two connection portions 19 located at opposite sides of the housing 10. The connection portions 19 protrude relative to the housing 10 in the second direction Y. The connection portions 19 are engaged with the extension portions 971 to connect the housing 10 to the outer casing 90.

In an exemplary embodiment of the present disclosure, the first outer casing 95 is a structure in the outer casing 90 configured to be connected to the housing 10, and the second outer casing 97 is a structure in the outer casing 90 configured to be engaged with the first outer casing 95 to jointly define the receiving cavity 93. The second outer casing 97 and the first outer casing 95 are connected to each other and jointly form the receiving cavity 93. The second outer casing 97 and the first outer casing 95 may be connected detachably or non-detachably. In this case, the outer casing 90 is easily disassembled, facilitating internal maintenance and repairment.

The extension portion 971 is a structure in the second outer casing 97 configured to be connected to the housing 10. Two extension portions 971 are provided, and in the present disclosure, a direction in which the two extension portions 971 are opposite to each other is defined as the first direction X. It should be understood that the first direction X and the second direction Y may be identical or different. The present disclosure is illustrated with the first direction X perpendicular to the second direction Y. In the second direction Y, the two extension portions 971 are opposite to and spaced apart from each other, and each extend relative to the inner side wall of the second outer casing 97 towards the receiving cavity 93 in the second direction Y. The extension portion 971 and the second outer casing 97 may be integrally formed as one piece or formed as separate pieces. When the extension portion 971 and the second outer casing 97 are formed as separate pieces, the extension portion 971 and the second outer casing 97 may be connected detachably or non-detachably.

Two connection portions 19 are also provided and correspond to the two extension portions 971, respectively. In the second direction Y, the two connection portions 19 are located at opposite sides of the housing 10 and each protrudes relative to the housing 10 in the second direction Y. The connection portion 19 and the housing 10 may be integrally formed as one piece or formed as separate pieces. If the connection portion 19 and the housing 10 are formed as separate pieces, the connection portion 19 and the housing 10 may be connected detachably or non-detachably.

The corresponding connection portions 19 and extension portions 971 can be engaged with and connected to each other to achieve a fixed connection between the housing 10 and the outer casing 90. In some embodiments, the connection portion 19 and the extension portion 971 each have a threaded hole and are connected by screws. In other embodiments, the connection portion 19 is in a plug-in connection or in a snap-fit connection with the extension portion 971. In some embodiments, the socket assembly 100 is mounted in the fixed-position structure, such as the wall. When deviation or inclination relative to a reference datum (e.g., ground) occurs during mounting of the outer casing 90 in the wall, the housing 10 can be corrected to a predetermined position relative to the reference point by adjusting an engagement relationship between the connection portion 19 and the extension portion 971, ensuring mounting aesthetics of the socket assembly 100.

Therefore, in the socket assembly 100 of the present disclosure, the two extension portions 971 that are opposite to and spaced apart from each other are disposed at the second housing 97, and the housing 10 includes two connection portions 19 protruding in the second direction Y. The two connection portions 19 can be engaged with the two extension portions 971, respectively, to connect the housing 10 to the outer casing 90. In this case, the socket assembly 100 has good mounting stability and can be fine-tuned within a certain dimensional range, providing good mounting flexibility and facilitating subsequent maintenance.

As illustrated in FIG. 9, it should be understood that the receiving cavity 93 is larger than the housing 10 in terms of volume. In this case, there is extra space inside the outer casing 90, allowing the phase line, the neutral line, and the protective earth line to be stacked and arranged in the receiving cavity 93 to provide a longer redundant length. This redundancy is intended to compensate for length loss caused by repeated wire trimming during subsequent maintenance, ensuring that the wire always has sufficient connection allowance, which is beneficial to improving long-term operational reliability and maintenance convenience of the socket assembly 100.

As illustrated in FIG. 2, FIG. 10, and FIG. 12, in some embodiments, a path 40 is disposed between the first connection terminal 30 and the second connection terminal 50. A switch 41 is disposed in the path 40, and configured to be opened when the energy storage power supply 300 is connected to the second connection terminal 50.

In an exemplary embodiment of the present disclosure, the path 40 is a structure configured to realize the electrical connection between the first connection terminal 30 and the second connection terminal 50. The path 40 can be selectively conducted or broken, to allow the second connection terminal 50 and the output terminal 80 to be selectively connected directly to the utility power via the path 40. The switch 41 is a component configured to control the conduction and breaking of the path 40. The switch 41 is disposed at the path 40 and can be closed to conduct the path 40 or opened to break the path 40. It should be understood that switch 41 can be manually controlled by the user or automatically controlled by the socket assembly 100 or the energy storage power supply 300, which is not limited in the present disclosure.

In some embodiments, the switch 41 needs to be opened when the energy storage power supply 300 is connected and to be closed when the energy storage power supply 300 is not connected. This ensures that the socket assembly 100 is still supplied with power normally when the energy storage power supply 300 is not connected and is supplied with power by the energy storage power supply 300 when the energy storage power supply 300 is connected. In this case, when the energy storage power supply 300 fails or is used for other purposes, the first connection terminal 30 can be electrically connected to the second connection terminal 50 directly through the path 40, transmitting the electric energy outputted by the first connection terminal 30 to the second connection terminal 50, and supplying power to the load 800 through the output terminal 80. In addition, when the utility power fails, the energy storage power supply 300 is activated to supply power in a grid-disconnected mode. An alternating current phase of the energy storage power supply 300 is controlled by itself. If the utility power is suddenly restored, an alternating current phase of the utility power is most likely to be inconsistent with the alternating current phase of the energy storage power supply 300, which would damage the load 500. By setting the switch 41, a problem of the utility power and the energy storage power supply 300 simultaneously supplying power to the second connection terminal 50 when the energy storage power supply 300 is in the grid-disconnected mode can also be avoided.

As illustrated in FIG. 10, in some embodiments, the socket assembly 100 further includes a control device 42 configured to obtain a connection state between the energy storage power supply 300 and the second connection terminal 50. The control device 43 is further configured to control the switch 41 to conduct the path 40 when the energy storage power supply 300 is disconnected from the second connection terminal 50, and/or to open the switch 41 to break the path 40 when the energy storage power supply 300 is connected to the second connection terminal 50.

In an exemplary embodiment of the present disclosure, the control device 43 is a device in the socket assembly 100 that applies a specific action to a controlled object according to predetermined logic or algorithms. The control device 43 is disposed inside the housing 10 in such a manner that the housing 10 can protect and accommodate the control device 43, preventing the control device 43 from damage caused by external force. The control device 43 can be in communication with the switch 41, such as wired communication or wireless communication, in such a manner that the control device 43 can control a closing state of the switch 41.

The control device 43 has a current sensing function. When the energy storage power supply 300 is connected to the second connection terminal 50, the control device 43 senses a current between the second connection terminal 50 and the output terminal 80. The control device 43 controls the switch 41 to break the path 40. In this case, the utility power is unable to supply power to the second connection terminal 50 and the output terminal 80 through the first connection terminal 30 and the path 40, but instead supplies power directly to the load 500 through the energy storage power supply 300.

When the energy storage power supply 300 is disconnected from the second connection terminal 50, the control device 43 senses no current between the second connection terminal 50 and the output terminal 80 and controls the switch 41 to conduct the path 40. In this case, the utility power can supply power to the second connection terminal 50 and the output terminal 80 through the first connection terminal 30 and the path 40, to allow the load 500 to directly obtain the electric energy from the utility power.

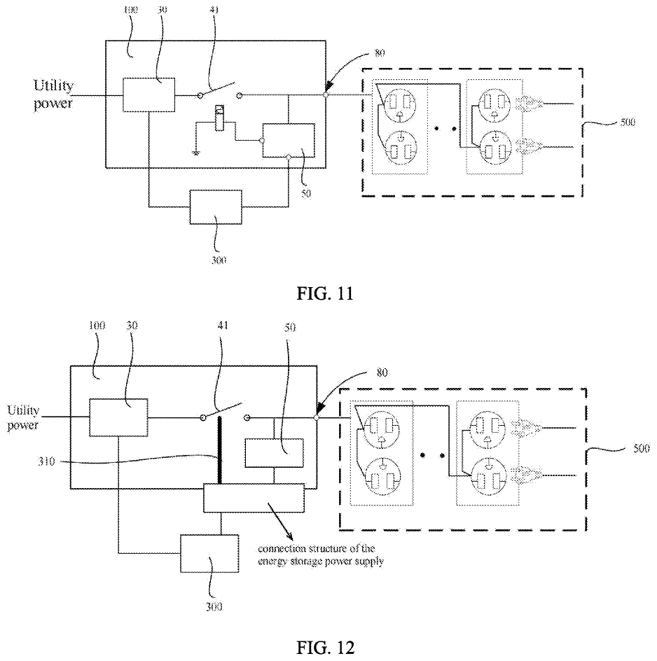

As illustrated in FIG. 11, in some embodiments, the switch 41 is operable in response to the connection state between the energy storage power supply 300 and the second connection terminal 50. The switch 41 is configured to be closed to conduct the path 40 when the energy storage power supply 300 is disconnected from the second connection terminal 50. The switch 41 is configured to be opened to break the path 40 when the energy storage power supply 300 is connected to the second connection terminal 50.

In an exemplary embodiment of the present disclosure, the switch 41 is automatically operable in response to the connection state between the energy storage power supply 300 and the second connection terminal 50. Exemplarily, the switch 41 is a normally closed relay that is electrically connected to the second connection terminal 50. The closing and opening of the switch 41 are determined by the connection state between the energy storage power supply 300 and the second connection terminal 50.

When the energy storage power supply 300 is connected to the second connection terminal 50, the normally closed relay is energized and breaks the path 40. In this case, the utility power fails to supply power to the second connection terminal 50 and the output terminal 80 through the first connection terminal 30 and the path 40, but instead supplies power directly to the load 500 through the energy storage power supply 300.

When the energy storage power supply 300 is disconnected from the second connection terminal 50, the normally closed relay is de-energized and conducts the path 40. In this case, the utility power can supply power to the second connection terminal 50 and the output terminal 80 through the first connection terminal 30 and the path 40, to enable the load 500 to directly obtain the electric energy from the utility power.

As illustrated in FIG. 12, in some embodiments, the energy storage power supply 300 includes a triggering member 310. The switch 41 is configured to be closed to conduct the path 40 when the energy storage power supply 300 is disconnected from the second connection terminal 50. When the energy storage power supply 300 is connected to the second connection terminal 50, the triggering member 310 abuts against the switch 41 to break the path 40.

In an exemplary embodiment of the present disclosure, the triggering member 310 is a structure in the energy storage power supply 300 configured to control the closing state of the switch 41. Exemplarily, the triggering member 310 is a pin disposed at a connection structure of the energy storage power supply 300 and can be mated with the switch 41 when the energy storage power supply 300 is inserted into the second connection terminal 50. In some embodiments, the switch 41 is an auxiliary microswitch, which makes the engagement between the switch 41 and the triggering member 310 more sensitive.

When the energy storage power supply 300 is not connected to the second connection terminal 50, the switch 41 is in an initial state under the action of gravity, elastic force, or magnetic force, and conducts the path 40. In this case, the utility power can supply power to the second connection terminal 50 and the output terminal 80 through the first connection terminal 30 and the path 40, to allow the load 500 to directly obtain the electric energy from the utility power.

When the energy storage power supply 300 is connected to the second connection terminal 50, the triggering member 310 abuts against the switch 41 and applies a driving force to the switch 41. In this case, the switch 41 moves under the action of the driving force and breaks the path 40. In this case, the utility power fails to supply power to the second connection terminal 50 and the output terminal 80 through the first connection terminal 30 and the path 40, but instead the load 500 is supplied power directly by the energy storage power supply 300. It should be understood that a process of the user connecting the energy storage power supply 300 to the second connection terminal 50 can be performed manually or automatically through other triggering mechanisms, such as through a robotic arm.

In some embodiments, a tactile switch or a photoelectric switch is disposed at the second connection terminal 50. In this case, the second connection terminal 50 has a function of automatically sensing a connection state of the energy storage power supply 300.

In the case where the tactile switch is disposed at the second connection terminal 50, when the energy storage power supply 300 is connected to the second connection terminal 50, the energy storage power supply 300 at least partially comes into physical contact with the tactile switch and presses an actuator of the tactile switch (i.e., a spring contact or button of the switch), which causes a change in a state of internal contacts of the tactile switch, breaking the path 40. Conversely, when the energy storage power supply 300 is disconnected from the second connection terminal 50, mechanical pressure applied to the actuator disappears, and the tactile switch, relying on a restoring force of its internal restoring structure, such as a spring mechanism, returns the contact to its initial state and conducts the path 40.

In the case where the photoelectric switch is disposed at the second connection terminal 50, when the energy storage power supply 300 is connected to the second connection terminal 50, an optical path between a transmitter (e.g., an infrared light emitting diode) and a receiver (e.g., a photosensitive receiving tube) in the photoelectric switch is blocked, in such a manner that the receiver undergoes an internal circuit state transition due to an inability to receive light, breaking the circuit path 40. Conversely, when the energy storage power supply 300 is disconnected from the second connection terminal 50, the optical path between the transmitter and the receiver remains unobstructed, the receiver continuously receives the light, and the photoelectric switch performs control to conduct the path 40.

It should be understood that controlling the switch 41 based on whether the energy storage power supply 300 is connected to the first connection terminal 30 serves no practical purpose. If the energy storage power supply 300 is only connected to the second connection terminal 50, and the switch 41 is closed, the utility power would be suddenly recovered and supplies power to the output terminal simultaneously with the energy storage power supply 300. The phases and voltages of the utility power and the energy storage power supply 300 are not synchronized, generating a huge circulating current that would cause damage to the load 500. Therefore, as described above, it is more reasonable to control the opening and closing of the switch 41 based on whether the energy storage power supply 300 is connected to the second connection terminal 50.

Therefore, in the socket assembly 100 of the present disclosure, the closing and opening of the switch 41 are controlled based on whether the energy storage power supply 300 is connected to the second connection terminal 50. In this way, the socket assembly 100 features high operational reliability and safety, the energy storage power supply 300 operates stably in the grid-disconnected mode, and the load 500 is not easily damaged.

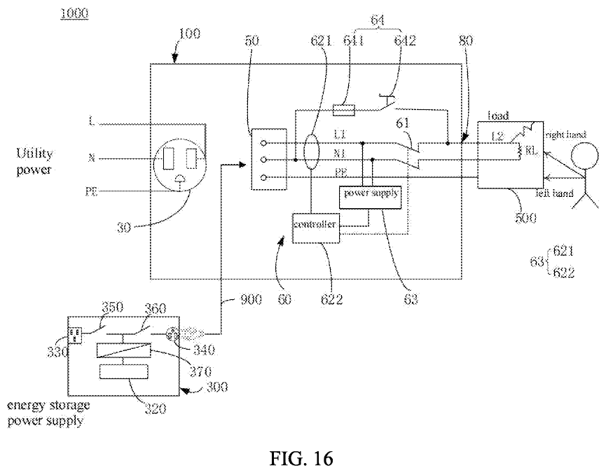

As illustrated in FIG. 1, FIG. 8, and FIG. 16, in some embodiments, the socket assembly 100 further includes a leakage protection circuit 60. The leakage protection circuit 60 includes a detection unit 621, a controller 622, and a connection switch 61. The detection unit 621 is configured to collect current signals of a phase line and a neutral line of the output terminal 80 in real time. The controller 622 is electrically connected to the detection unit 621. The connection switch 61 is disposed on each of the phase line and the neutral line of the output terminal 80. The controller 622 is configured to control the connection switch 61 to be opened based on an abnormal signal collected by the detection unit 621.

In an exemplary embodiment of the present disclosure, the leakage protection circuit 60 is a safety protection circuit that monitors a current balance state between the phase line (denoted as L1 in FIG. 16) and the neutral line (denoted as N1 in FIG. 16) in a power supply circuit in real time. When situations of current imbalance caused by electric shock to the human body (e.g., current flowing into the body from the right hand and out through the left hand), damage to line insulation, electric leakage from the load 500, etc., the electrical connection between the second connection terminal 50 and the load 500 is quickly and automatically disconnected, to protect device safety and user electrical safety.

It should be understood that the phase line of the utility power (denoted as L in FIG. 16) is connected to the socket assembly 100 through the live terminal 73 and connected to the phase line (denoted as L1 in FIG. 16) that is connected to the output terminal 80 when the energy storage power supply 300 is connected. The neutral line (denoted as N in FIG. 16) of the utility power is connected to the socket assembly 100 through the neutral terminal 75 and connected to the neutral line (denoted as N1 in FIG. 16) of the output terminal 80 when the energy storage power supply 300 is connected.

When the detection unit 621 collects an abnormal signal, for example, when electric leakage occurs from the phase line (denoted as L2 in FIG. 16) in the load 500 to the outer casing of the load 500, and a grounding circuit of the load 500 is closed, a current of the phase line partially flows back to the neutral line through the grounding circuit (denoted as PE in FIG. 16). In this case, currents in the phase line and the neutral line are imbalanced. When a difference between the currents in the phase line and the neutral line reaches a certain threshold, the leakage protection circuit 60 quickly opens the phase line circuit and disconnects the electrical connection between the second connection terminal 50 and the load 500, which ensures that no current flows into the load 500 under electric leakage conditions, guaranteeing electrical safety of the user.

The leakage protection circuit 60 is disposed in the socket assembly 100, and does not occupy extra space, making a structure of the socket assembly 100 more compact and reducing usage costs. In addition, the leakage protection circuit 60 is a circuit between the second connection terminal 50 and the load 500. Therefore, electric leakage protection is achieved by disconnecting the electrical connection between the second connection terminal 50 and the load 500. In this way, the leakage protection circuit 60 can achieve the electric leakage protection regardless of whether the load 500 is supplied with power by the utility power or by the energy storage power supply 300. Thus, the leakage protection circuit 60 has high economic practicality.

As illustrated in FIG. 8, FIG. 8 is a schematic view showing a connection between a socket assembly 100 and an energy storage power supply 300 according to an embodiment of this application. In some embodiments, the energy storage power supply 300 is internally provided with a switch (hereinafter referred to as the first switch 350 and the second switch 360). The switch is configured to connect the utility power access terminal 70 to the leakage protection circuit 60 when the utility power is connected or in an off-peak price state, to supply power to the load 500 and/or the energy storage power supply 300 through the utility power. The switch is configured to connect the energy storage power supply 300 to the leakage protection circuit 60 when the utility power is disconnected or in a non-off-peak price state, to supply power to the load 500 through the energy storage power supply 300.

It should be understood that, as illustrated in FIG. 15, as described above, the socket assembly 100 may be located downstream of the branch switch or upstream of the branch switch. When the leakage protection circuit 60 of the socket assembly 100 detects the abnormal signal, the connection switch 61 of the leakage protection circuit 60 is opened to protect the load 500, ensuring the electrical safety of the load 500 when the utility power is normal or power fails. The leakage protection circuit 60 is disposed inside the socket assembly 100, improving an integration level of the socket assembly 100 without affecting its appearance.

The detection unit 621 is a device configured to collect current information between the phase line and the neutral line of the power supply circuit of the load 500. The detection unit 621 may be disposed between the connection switch 61 and the second connection terminal 50. Exemplarily, the detection unit 621 may be a current sensor and collect current information between the phase line and the neutral line. The controller 622 controls the closing and opening of the connection switch 61 based on the current information collected by the detection unit 621.

The controller 622 is responsible for receiving a detection signal of the detection unit 621 and controlling the opening and closing of the connection switch 61, ensuring stable, accurate, and rapid operation of the leakage protection circuit 60 under different power supply modes including power being supplied by the utility power and power being supplied by the energy storage power supply 300. A control assembly 62, that at least includes the detection unit 621 and the controller 622, is configured to control the opening and closing of the connection switch 61 to connect or disconnect the circuit between the second connection terminal 50 and the load 500. The control assembly 62 is a core control unit in the leakage protection circuit 60. The control assembly 62 is configured to monitor a loop current in real time, perform logical judgment, and output a control signal upon detecting the electric leakage to quickly break the power supply circuit.

The connection switch 61 is connected to the phase line of the power supply circuit between the second connection terminal 50 and the load 500. When the connection switch 61 is closed, an input current of the second connection terminal 50 flows to the load 500 through the phase line in the circuit, and the power supply circuit between the second connection terminal 50 and the load 500 operates normally. Exemplarily, the connection switch 61 is a normally closed relay.

When the load 500 experiences electric leakage due to a situation such as damage to power line or insulation aging, the control assembly 62 monitors the loop current in real time and controls connection switch 61 to be opened when the leakage current exceeds a certain threshold, to cut off the current input to the load 500, achieving real-time protection. By clearly dividing functions of the control assembly 62 and the connection switch 61, efficient and reliable operation of the leakage protection circuit 60 is achieved.

As illustrated in FIG. 1, FIG. 8, and FIG. 16, in some embodiments, the detection unit 621 is disposed between the output terminal 80 and the second connection terminal 50. The detection unit 621 is configured to collect current signals of a phase line and a neutral line between the second connection terminal 50 and the load 500 in real time. The controller 622 is electrically connected to the detection unit 621 and configured to, in response to the signal collected by the detection unit 621, control the connection switch 61 to be closed when no electric leakage occurs at the load 500, and control the connection switch 61 to be opened when electric leakage occurs at the load 500.

In an exemplary embodiment of the present disclosure, the detection unit 621 is disposed between the output terminal 80 and the second connection terminal 50, and configured to implement balance detection of the power supply circuit between the second connection terminal 50 and the load 500. For example, when no electric leakage occurs at the load 500, a current flowing from the phase line to the load 500 is equal to a current flowing back from the load 500 to the neutral line. Therefore, the currents of the phase line and the neutral line are balanced. In this case, the controller 622 is configured to control the connection switch 61 to be in a normally closed state, and the load 500 operates normally. When the electric leakage occurs at the load 500, the current flowing from the phase line to the load 500 partially flows to the grounding loop through the load 500. The current flowing from the phase line to the load 500 is not equal to the current flowing back to the neutral line from the load 500, in such a manner that currents of the phase line and the neutral line are imbalanced. In this case, the difference between the current of the phase line and the current of the neutral line is a magnitude of an electric leakage current in the power supply circuit. When the electric leakage current reaches a certain value, the controller 622 controls the normally closed connection switch 61 to be opened, to break the phase line path in the power supply circuit. The current is prevented from flowing into the load 500, achieving circuit break protection.

As illustrated in FIG. 1, FIG. 8, and FIG. 16, in some embodiments, the leakage protection circuit 60 further includes a power supply 63 connected to the controller 622 and the phase line and configured to supply power to the controller 622.

In the above-described embodiments, the power supply 63 provides a stable operating voltage to the controller 622, guaranteeing the normal operation of the leakage protection circuit 60.

In an exemplary embodiment of the present disclosure, the power supply 63 is an alternating current-direct current conversion module that provides an operating power supply 63 for the controller 622. The power supply 63 has an end connected to a utility power alternating current power supply and another end outputting low-voltage direct current power. The low-voltage direct current power is electrically connected to the controller 622, providing the controller 622 with a stable and isolated operating voltage. For example, the power supply 63 converts the 220V alternating current of the utility power into low-voltage direct current such as 5V, 12V, or 24V required by the controller 622, providing operating power to the controller 622 and ensuring the normal operation of the control circuit such as electric leakage detection, signal processing, and control signal output. The power supply 63 can perform voltage regulation on the direct current voltage output by the controller 622 to ensure that the controller 622 can still operate reliably when the utility power fluctuates. Exemplarily, the power supply 63 can also realize electrical isolation between a high-voltage main circuit and a low-voltage control circuit, improving safety and preventing electric shock and interference.

As illustrated in FIG. 1, FIG. 8, and FIG. 16, in some embodiments, the leakage protection circuit 60 further includes an analog circuit 64 having a terminal connected to the phase line between the second connection terminal 50 and the load 500 and another terminal connected to the neutral line for verifying effectiveness of the control assembly 62.

In the above-described embodiments, the analog circuit 64 can verify the effectiveness of the controller 622 at any time and promptly detect relevant faults to ensure long-term effective operation of the controller 622 and protect long-term safety of the circuit.

In an exemplary embodiment of the present disclosure, the analog circuit 64 is a dedicated circuit in the leakage protection circuit 60 configured to simulate electric leakage faults to verify whether the protection function of the control assembly 62 in the leakage protection circuit 60 is effective. Based on detection of the electric leakage current and an electric leakage protection method of the control assembly 62, the analog circuit 64 simulates leakage current to artificially generate a known, safe, and controllable simulated electric leakage current. Therefore, the analog circuit 64 detects an imbalance between a current flowing from the phase line into the load 500 and a current returning to the neutral line from the load 500. Consequently, the controller 622 controls the connection switch 61 to be opened based on the unbalanced current information, cutting off the current input to the load 500.

Exemplarily, if the control assembly 62 can detect the unbalanced electric leakage information and open the connection switch 61, it can indicate the effectiveness of the protection function of the control assembly 62. Conversely, if the control assembly 62 fails to detect the unbalanced current information caused by the analog circuit 64 or fails to open the connection switch 61 in a timely manner, it indicates a failure of the control assembly 62.

In this way, by disposing the analog circuit 64 on the leakage protection circuit 60, functional integration and structural compactness of the socket assembly 100 are further improved. The user can perform self-inspection at any time to confirm that the leakage protection circuit 60 is not faulty or damaged, ensuring reliable operation in the event of actual electric leakage or electric shock, and avoiding safety hazards such as electric shock and fire caused by the failure of the control assembly 62 of the leakage protection circuit 60.

As illustrated in FIG. 1, FIG. 8, and FIG. 16, in some embodiments, the analog circuit 64 includes a resistor element 641 and a circuit switch 642. A first terminal of the resistor element 641 is connected to the neutral line, a second terminal of the resistor element 641 is connected to a first terminal of the circuit switch 642, and a second terminal of the circuit switch 642 is connected to the phase line. When the circuit switch 642 is closed, a current flowing from the second connection terminal 50 partially flows to the neutral line, to alter the current signal collected by the detection unit 621.

In the above-described embodiments, the effectiveness of the control assembly 62 can be verified at any time by closing the circuit switch 642. Therefore, the operation method is simple, and the detection method is reliable and easy to implement.

In an exemplary embodiment of the present disclosure, the analog circuit 64 is composed of the resistor element 641 and the circuit switch 642 that are connected in series. The first terminal of the resistor element 641 is connected to the neutral line, the second terminal of the resistor element 641 is connected to the first terminal of the circuit switch 642, and the second terminal of the circuit switch 642 is connected to the phase line. The analog circuit 64 is connected across the phase line and the neutral line of the power supply circuit. The resistor element 641 can limit the simulated leakage current within a safe and standard predetermined range to avoid circuit damage caused by excessive current, while providing a stable and standard test current to ensure reliable leakage protection operation. The circuit switch 642 is a switching element that controls the closing and opening of the analog circuit 64 and triggers the verification process of the leakage protection function. The circuit switch 642 of the analog circuit 64 is a normally open switch.

When the effectiveness of the leakage protection circuit 60 needs to be verified, the circuit switch 642 can be manually or intelligently closed. When the circuit switch 642 is closed, a current that originally flowed from the phase line in the power supply circuit to the load 500 partially flows to the resistor element 641 and then to the neutral line. In this case, the current flowing out of the phase line and the current flowing back from the load 500 to the neutral line are unbalanced, to simulate the unbalanced current information collected by the detection unit 621 of the control assembly 62 under electric leakage conditions, thereby verifying the effectiveness of the control assembly 62.

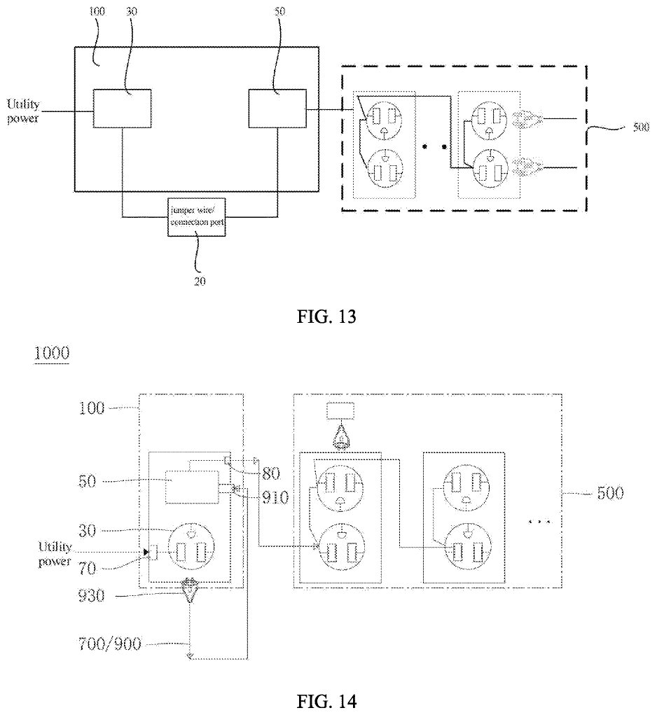

As illustrated in FIG. 13, in some embodiments, one of the first connection terminal 30 or the second connection terminal 50 is configured as a wired connection port. The connection port is capable of being connected to the other one of the first connection terminal 30 or the second connection terminal 50, to connect the first connection terminal 30 to the second connection terminal 50.

In the above-described embodiments, the first connection terminal 30 being the wired connection port connected to the second connection terminal 50 are taken as an example for illustration. For an embodiment where the second connection terminal 50 is the wired connection port connected to the first connection terminal 30, please refer to the following description.

The connection port may be a connection wire and a structure, such as a socket or a plug, located at an end of the connection wire for connection. In this case, the second connection terminal 50 engaged with the connection port is provided with a plug or a socket engaged with the structure. When the connection port is configured in the first connection terminal 30, the electrical connection between the first connection terminal 30 and the second connection terminal 50 can be achieved simply and quickly. The socket assembly 100 can ensure that the second connection terminal 50 can still be energized even when the energy storage power supply 300 is not connected, to ensure continuity and reliability of the power supply to the load 500 and improve the user experience of the socket assembly 100.

As illustrated in FIG. 13, in some embodiments, the socket assembly 100 further includes a jumper wire 20 configured to connect the first connection terminal 30 to the second connection terminal 50.

In the above-described embodiments, the jumper wire is a structure configured to achieve an electrical connection between the first connection terminal 30 and the second connection terminal 50. The jumper wire is a wire independent of the first connection terminal 30 and the second connection terminal 50. It should be understood that two ends of the jumper wire 20 include connection structures that are engaged with the first connection terminal 30 and the second connection terminal 50, respectively. In this case, the electrical connection between the first connection terminal 30 and the second connection terminal 50 can be easily and quickly achieved through the jumper wire 20. The socket assembly 100 can ensure that the second connection terminal 50 can still be energized even when the energy storage power supply 300 is not connected, to ensure the continuity and reliability of the power supply to the load 500, improving the user experience of the socket assembly 100.

As illustrated in FIG. 1, FIG. 2, FIG. 8, and FIG. 14, in some embodiments, the socket assembly 100 has a first connection mode and a second connection mode. In the first connection mode, the second connection terminal 50 is in a pluggable electrical connection with the first connection terminal 30 via the jumper wire 20. In the second connection mode, the socket assembly 100 is connected to the energy storage power supply 300, the first connection terminal 30 is electrically connected to a power input interface 330 of the energy storage power supply 300, the second connection terminal 50 is electrically connected to a power output interface 340 of the energy storage power supply, the utility power supplies power to the load 500 through the power input interface 330 and the power output interface 340 of the energy storage power supply 300. When the utility power fails, the load 500 is supplied with power by electric energy outputted by the energy storage power supply 300.

In an exemplary embodiment of the present disclosure, the first connection mode and the second connection mode are two different operating modes of the socket assembly 100. In the first connection mode, as illustrated in FIG. 14, the first connection terminal 30 is electrically connected to the utility power, and the second connection terminal 50 is in a pluggable electrical connection with the first connection terminal 30 via the jumper wire 20. When the utility power is available, the electric energy of the utility power is inputted to the second connection terminal 50 through the first connection terminal 30, and then outputted from the second connection terminal 50 to the output terminal 80 and the load 500.

In the second connection mode, as illustrated in FIG. 8, the socket assembly 100 is connected to the energy storage power supply 300, the first connection terminal 30 is electrically connected to the utility power, the first connection terminal 30 is electrically connected to the power input interface 330 of the energy storage power supply 300 (described below) via a connection structure, such as a first connection line 700 described below, and the electric energy from the utility power can be transmitted to the power input interface 330 of the energy storage power supply 300 via the first connection terminal 30. The second connection terminal 50 can be electrically connected to the power output interface 340 of the energy storage power supply 300 (described below) via the connection structure, such as a second connection line 900 described below, the second connection terminal 50 and the output terminal 80 are electrically connected to the load 500, and the second connection terminal 50 can transmit the electric energy outputted from the energy storage power supply 300 to the load 500. When the utility power is available, the electric energy from the utility power is inputted to the power input interface 330 of the energy storage power supply 300 through the first connection terminal 30, outputted to the second connection terminal 50 through the power output interface 340, outputted to the output terminal 80 from the second connection terminal 50, and then supplied to the load 500. When the utility power fails, the energy storage power supply 300 can automatically switch over, and the electric energy stored in the energy storage power supply 300 continues supplying power to the load 500 through the second connection terminal 50 and the output terminal 80, ensuring continuous power supply to the load 500.

As illustrated in FIG. 2 to FIG. 5, in some embodiments, the first connection terminal 30 includes a first protection shell 31 and a connection terminal 37 disposed in the first protection shell 31. The connection terminal 37 is configured to be electrically connected to the energy storage power supply 300. Outer walls of the first protection shell 31 and/or the connection terminal 37 are non-conductive.

In the above-described embodiments, it should be noted that the specific structure and properties of the first connection terminal 30 in this embodiment are completely identical to those of the first connection terminal 30 in the embodiments described above, and repeated description thereof will be omitted herein.

The connection terminal 37 is a structure in the first connection terminal 30 configured to be electrically connected to the energy storage power supply 300. The connection terminal 37 is disposed in the first protection shell 31 and can be mated with the plug of the energy storage power supply 300. It should be understood that a configuration of the plug of the energy storage power supply 300 corresponds to a combination configuration of the first protection shell 31 and the connection terminal 37 to ensure that the plug of the energy storage power supply 300 can be in a plug-in connection with the first connection terminal 30.

When the outer walls of the first protection shell 31 and/or the connection terminal 37 are non-conductive, the first connection terminal 30 forms a physical isolation barrier, which can effectively prevent the user from accidentally touching live parts, eliminating a risk of electric shock at the source, complying with safety certification standards, and improving safety and a compliance level of the socket assembly 100.

As illustrated in FIG. 2 to FIG. 5, in some embodiments, the second connection terminal 50 includes a second protection shell 51 and a metal member 57. The second protection shell 51 has a jack 511. The metal member 57 is disposed corresponding to the jack 511.

In an embodiment, the second protection shell 51 has the jack 511, which can ensure that another plug of the energy storage power supply 300 can be smoothly inserted into the second connection terminal 50 and form electrical contact with the metal member 57. In this way, the electric energy from the energy storage power supply 300 can be outputted to the second connection terminal 50 and the output terminal 80. The number of jacks 511 may be two or three, and their shapes include, but are not limited to, rectangles, circles, and the like.

The metal member is a structure in the second connection terminal 50 configured to be electrically connected to the plug. The metal member 57 is electrically conductive. Exemplarily, the metal member 57 may be the protective grounding socket contact, the phase line socket contact, or the neutral line socket contact described above. The metal member 57 is disposed corresponding to the jack 511. The metal member 57 is made of a material including, but not limited to, copper, and has good electrical conductivity and an elastic structure. When the plug of the energy storage power supply 300 is connected to the second connection terminal 50 through the jack 511, the metal member 57 in the second connection terminal 50 can stably clamp the plug, guaranteeing the reliability of the electrical connection and maintaining good contact performance after long-term and repeated plugging and unplugging operations. Therefore, the electrical connection and mechanical connection between the energy storage power supply 300 and the second connection terminal 50 are stable and reliable, resulting in good practicality and safety of the socket assembly 100.

It should be understood that, the first protection shell 31 and the second protection shell 51 are also flame-retardant, effectively preventing flame spread and reducing fire risks when current overload or other faults occurs.

As illustrated in FIG. 2 to FIG. 5, in some embodiments, the first connection terminal 30 and the second connection terminal 50 are disposed in the housing 10.

In the above-described embodiments, the structure and properties of the housing 10 are as described above, and thus details thereof will be omitted here. When the first connection terminal 30 and the second connection terminal 50 are disposed in the housing 10, the housing 10 is configured to accommodate and protect the first connection terminal 30 and the second connection terminal 50, to improve structural strength or a service life of the socket assembly 100, better meeting user requirements.

As illustrated in FIG. 2 to FIG. 5, in some examples, the housing 10 has a first jack, and the first connection terminal 30 includes a metal member 57. The metal member 57 is disposed corresponding to the first jack.

In an exemplary embodiment of the present disclosure, the first jack (not shown) is a spatial structure on the housing 10, into which a structure connected to the first connection terminal 30 extends. The first jack can ensure that a structure configured to be connected to the first connection terminal 30 in the energy storage power supply 300, such as the plug, can be smoothly inserted into the first connection terminal 30 and form the electrical contact with the metal member 57, which can output the electric energy from the utility power to the energy storage power supply 300. The number of the first jacks may be two or three, and their shapes include, but are not limited to, rectangles, circles, and the like. The first connection terminal 30 includes the metal member 57 that is disposed corresponding to the first jack. The metal member 57 is made of a material including, but not limited to, copper, and has good electrical conductivity and the elastic structure. When the plug of the energy storage power supply 300 is connected to the first connection terminal 30 through the first jack, the metal member 57 in the first connection terminal 30 can stably clamp the plug, guaranteeing the reliability of the electrical connection and maintaining good contact performance after long-term and repeated plugging and unplugging operations.

As illustrated in FIG. 2 to FIG. 5, in other examples, the housing 10 has a second jack, and the second connection terminal 50 includes a connection interface. The connection interface is disposed corresponding to the second jack.

In an exemplary embodiment of the present disclosure, the second jack (not shown) is a spatial structure on the housing 10, into which a structure connected to the first connection terminal 30 extends. The shape of the second jack includes, but is not limited to, a circle, a rectangle, and the like. The second connection terminal 50 includes the connection interface (not shown) that is disposed corresponding to the second jack. The metal member 57 is disposed in the connection interface. When the structure configured to be connected to the second connection terminal 50 in the energy storage power supply 300, such as the plug, is connected to the second connection terminal 50 through the connection interface, the metal member 57 can stably clamp the plug, guaranteeing the reliability of the electrical connection.

Optionally, the connection interface is a safety connection interface where the internal metal member 57 cannot be touched by hand, preventing the risk of electric shock caused by accidental unplugging of the connection interface during the operation of the device.

It should be understood that specific configurations of the first connection terminal 30 and the second connection terminal 50 correspond to a specific configuration of a structure of the energy storage power supply 300 configured to be connected to the first connection terminal 30 and the second connection terminal 50.

As illustrated in FIG. 1 and FIG. 2, in a second aspect, the present disclosure provides an energy storage system 1000. The energy storage system 1000 includes an energy storage power supply 300 and a socket assembly 100. The energy storage power supply 300 is electrically connected to each of a first connection terminal 30 and a second connection terminal 50. The load 500 is capable of being supplied with power by the utility power or the energy storage power supply 300 through the socket assembly 100.

In an exemplary embodiment of the present disclosure, the energy storage system 1000 is a system configured for energy storage, dispatching, and utilization. The energy storage power supply 300 is a device configured to store and release energy. The energy storage power supply 300 may be a large-capacity, high-power, and multi-functional portable energy storage device, which may be applied to a grid-disconnected microgrid system and a grid-connected power grid system. When applied to the grid-disconnected microgrid system, the energy storage power supply 300 can replace traditional fuel generators and supply clean energy to the load in the grid-disconnected microgrid system. When applied to the grid-connected power grid system, in addition to supplying electric energy to the load in the power grid, the energy storage power supply 300 can also supply the electric energy to the utility power grid during periods of high electricity prices and when there is still surplus energy after supplying power to the load. Of course, the energy storage power supply 300 can also be applied in outdoor camping, emergency disaster relief, professional operations (such as photography and engineering), and other scenarios, to meet power requirements of areas without the power grid or with unstable power supply.

In the above-described embodiments, it should be noted that a specific structure and properties of the socket assembly 100 in this embodiment are completely identical to those of the socket assembly 100 in the embodiments described above, and repeated description thereof will be omitted herein. When connected to the socket assembly 100, the energy storage power supply 300 can be electrically connected to each of the first connection terminal 30 and the second connection terminal 50 via a plug, to allow the load 500 to be flexibly supplied, through the socket assembly 100, with power by the utility power or by the energy storage power supply 300.

In the energy storage system 1000 of the present disclosure, a utility power access terminal 70 of the socket assembly 100 is connected to the utility power via an electric wire. The first connection terminal 30 is electrically connected to the utility power access terminal 70 and can be in a pluggable connection with the energy storage power supply 300. The second connection terminal 50 is electrically connected to the output terminal 80 and can also be in a pluggable connection with the energy storage power supply 300. In this case, the load 500 can be optionally supplied with power by the utility power or the energy storage power supply 300 through an electrical connection with the output terminal 80, to achieve flexible electric energy dispatching. Therefore, the socket assembly 100 of the present disclosure only needs to be connected to a circuit through the utility power access terminal 70 and the output terminal 80, respectively, without the need for complex wiring connections and assembly of accessories (such as a slave distribution box). Therefore, mounting time and labor costs are low, resulting in good economy and convenience.

As illustrated in FIG. 1, FIG. 2, and FIG. 8, in some embodiments, the energy storage system 1000 has a first operating mode and a second operating mode. In the first operating mode, when the utility power is connected or in an off-peak price state, the utility power charges the energy storage power supply 300 and/or supplies power to the load 500 through the energy storage power supply 300, the second connection terminal 50, and the output terminal 80. In the second operating mode, when the utility power is disconnected, or in a non-off-peak price state, the energy storage power supply 300 supplies power to the load 500 through the second connection terminal 50 and the output terminal 80.

As illustrated in FIG. 1, FIG. 2, and FIG. 8, in some embodiments, the energy storage system 1000 also has a further sub-mode of the second operating mode. In the further sub-mode of the second operating mode, when the utility power is connected or in the off-peak price state, the utility power supplies power to the load 500 through the energy storage power supply 300, the second connection terminal 50, and the output terminal 80, and the energy storage power supply 300 supplies power to the load 500 through the second connection terminal 50 and the output terminal 80. That is, the energy storage power supply 300 is in the grid-connected operating mode described above.

As illustrated in FIG. 1, FIG. 2, and FIG. 8, in some embodiments, the energy storage power supply includes a battery module 320, a power input interface 330, a power output interface 340, a first switch 350, a second switch 360, and an inverter 370. The battery module 320 is configured to store and release electric energy. The power input interface 330 is electrically connected to the first connection terminal. The power output interface 340 is configured to be electrically connected to the second connection terminal. The power input interface 330 is connected to the power output interface 340 sequentially via the first switch 350 and the second switch 360. The inverter 370 has an end connected between the first switch 350 and the second switch 360 and another end connected to the battery module 320. In the first operating mode, both the first switch 350 and the second switch 360 are closed, and the inverter 370 is in a rectification mode, to enable the inverter 370 to charge the battery module 320 using the utility power. In the second operating mode, the first switch 350 is opened, the second switch 360 is closed, and the inverter 370 is in an inverter mode, to enable the electric energy of the battery module 320 to be outputted to the second connection terminal through the inverter 370.

In an exemplary embodiment of the present disclosure, the power input interface 330 is an interface for the energy storage power supply 300 to receive the electric energy. The power output interface 340 is an interface for the energy storage power supply 300 to output the electric energy. The first connection terminal 30 transmits the electric energy from the utility power to the power input interface 330 of the energy storage power supply 300. The first switch 350 has a terminal electrically connected to the power input interface 330 of the energy storage power supply 300 and another terminal electrically connected to each of the input terminal of the inverter 370 and the second switch 360. In this way, the electric energy of the utility power inputted from the power input interface 330 of the energy storage power supply 300 is transmitted to the second switch 360 and the inverter 370.

The second switch 360 has a terminal electrically connected to each of the first switch 350 and the inverter 370 and another terminal electrically connected to the power output interface 340 of the energy storage power supply 300, which can output the electric energy inputted to the second switch 360 to the power output interface 340 of the energy storage power supply 300. The power input interface 330 of the energy storage power supply 300 is connected to the power output interface 340 of the energy storage power supply 300 sequentially via the first switch 350 and the second switch 360. It should be understood that the first switch 350 is switch K1 in FIG. 8, and the second switch 360 is switch K2 in FIG. 8.

The inverter 370 is a structure in the energy storage power supply 300 configured to convert between an alternating current and a direct current. The battery module 320 is a structure in the energy storage power supply 300 configured to store and release the electric energy. The inverter 370 has a terminal connected between the first switch 350 and the second switch 360 and another terminal connected to the battery module 320. The inverter 370 is an electronic device capable of converting the alternating current to the direct current and vice versa. An operation in which the inverter 370 converts the alternating current to the direct current is called the rectification mode, and an operation in which the inverter 370 converts the direct current to the alternating current is called the inverter mode.

The battery module 320 is connected to the inverter 370. The battery module 320 includes a battery cell configured to store the electric energy. The battery module 320 can store the direct current outputted from the inverter 370 in the battery cell, and can also convert the electric energy stored in the battery cell into the alternating current through the inverter 370 and output the alternating current to the power output interface 340 of the energy storage power supply 300.

It should be understood that, an electric quantity stored in the battery module 320 is positively correlated with the number of battery cells and energy density of the battery cells. The electric quantity stored in the battery module 320 via the inverter 370 increases as the number of battery cells increases and the energy density becomes higher. Conversely, the electric quantity stored in the battery module 320 via the inverter 370 decreases as the number of battery cells decreases and the energy density becomes lower.

As illustrated in FIG. 8, in the first operating mode, both the first switch 350 and the second switch 360 are closed, and the inverter 370 is in the rectification mode. The inverter 370 converts the alternating current outputted from the first switch 350 into the direct current, which is then stored in the battery module 320, storing the electric energy. In the second operating mode, the first switch 350 is opened and the second switch 360 is closed. Since no electric energy is input from the utility power, the inverter 370 enters the inverter mode, converts the electric energy stored in the battery module 320 into the alternating current, and supplies the alternating current to the power output interface 340 of the energy storage power supply 300, supplying power to the second connection terminal via the receptacle connector.

Therefore, in the energy storage system 1000 of the present disclosure, the energy storage power supply 300 can automatically switch closing states of the first switch 350 and the second switch 360 based on a state of the utility power, to achieve flexible power supply to the load 500.

As illustrated in FIG. 1, FIG. 2, and FIG. 8, in some embodiments, both the first switch 350 and the second switch 360 include a relay.

In an exemplary embodiment of the present disclosure, the relay, which is an electrical component that achieves automatic switching control using electromagnetic principles, converts the electric energy into mechanical energy, which is then used to control an on/off state of a circuit. As illustrated in FIG. 8, in the first operating mode, the relays of the first switch 350 and the second switch 360 are closed, the electric energy outputted through the power input interface 330 of the energy storage power supply 300 is transmitted to the second connection terminal 50 and the output terminal 80, and the battery module 320 is charged through the inverter 370. In the second operating mode, the relay of the first switch 350 is opened, and the relay of the second switch 360 is closed. The inverter 370 converts the electric energy stored in the battery module 320 into the alternating current, which then supplies power to the load 500 through the second connection terminal 50 and the output terminal 80. Therefore, in the energy storage system 1000 of the present disclosure, the relay plays a role in improving safety of the energy storage system 1000.

As illustrated in FIG. 1, FIG. 2, and FIG. 13, in some embodiments, the energy storage system 1000 has a third operating mode. In the third operating mode, in a case where the energy storage power supply 300 is disconnected from the first connection terminal 30 and the second connection terminal 50, the first connection terminal 30 is connected to the second connection terminal 50 through a jumper wire 20, and the utility power is available, the utility power supplies power to the load 500 through the socket assembly 100.

In an exemplary embodiment of the present disclosure, as described above, when the energy storage power supply 300 fails or is used for other purposes, the energy storage system 1000 is in the third operating mode. In this mode, the energy storage power supply 300 is disconnected from the utility power, and the first connection terminal 30 can be directly connected to the second connection terminal 50 through the jumper wire 20. When the utility power is available, the utility power directly transmits the electric energy to the second connection terminal 50 through the first connection terminal 30. The second connection terminal 50 then transmits the inputted electric energy to the output terminal 80 to supply power to the load 500. Therefore, the energy storage system 1000 of the present disclosure can enable the utility power to supply power to the load 500 normally without passing through the energy storage power supply 300.

As illustrated in FIG. 1, FIG. 2, FIG. 8, and FIG. 14, in some embodiments, the energy storage system 1000 includes a first connection line 700 and a second connection line 900. The first connection line 700 is provided with a first connector 710 and a second connector 730 at two ends of the first connection line 700, respectively. The first connector 710 is configured to be in a plug-in connection with the first connection terminal 30, and the second connector 730 is configured to be in a plug-in connection with the power input interface 330 or the second connection terminal 50. The second connection line 900 is provided with a third connector 910 and a fourth connector 930 respectively at two ends of the second connection line 900. The third connector 910 is configured to be in a plug-in connection with the second connection terminal 50, and the fourth connector 930 is configured to be in a plug-in connection with the power output interface 340 or the first connection terminal 30.

In an exemplary embodiment of the present disclosure, the first connection line 700 and the second connection line 900 are structures in the energy storage system 1000 configured to be electrically connected the energy storage power supply 300 and the socket assembly 100. The first connection line 700 includes the first connector 710 and the second connector 730, and the second connection line 900 includes the third connector 910 and the fourth connector 930.

As illustrated in FIG. 8, in an embodiment, the first connector 710 is configured to be in a plug-in connection with the first connection terminal 30, and the second connector 730 is configured to be in a plug-in connection with the power input interface 330. The electric energy outputted from the first connection terminal 30 can be inputted to the energy storage power supply 300 through the first connection line 700. The third connector 910 and the fourth connector 930 are disposed at two ends of the second connection line 900. The third connector 910 is configured to be in a plug-in connection with the second connection terminal 50, and the fourth connector 930 is configured to be in a plug-in connection with the power output interface 340. The electric energy outputted from the energy storage power supply 300 can be transmitted to the second connection terminal 50 through the second connection line 900.

As illustrated in FIG. 14, in an embodiment, the third connector 910 is configured to be in a plug-in connection with the second connection terminal 50, and the fourth connector 930 is configured to be in a plug-in connection with the first connection terminal 30. The first connection terminal 30 is connected to the second connection terminal 50 through the second connection line 900, and the electric energy outputted from the first connection terminal 30 is directly inputted to the second connection terminal 50 through the second connection line 900. It should be understood that the second connection line 900 in this case is the jumper wire 20 described above. In addition, the first connection line 700 may also be the jumper wire 20. In an exemplary embodiment of the present disclosure, the first connector 710 is configured to be in a plug-in connection with the second connection terminal 50, and the second connector 730 is configured to be in a plug-in connection with the first connection terminal 30. Therefore, in the energy storage system 1000 of the present disclosure, the connection between the socket assembly 100 and the energy storage power supply 300, as well as the connection between the second connection terminal 50 and the first connection terminal 30, can be easily achieved through the first connection line 700 and the second connection line 900.

Any combination of technical features in the above-described embodiments may be adopted. To make the description simple, all possible combinations of the technical features in the above-described embodiments are not described. However, as long as there is no conflict between the technical features in the embodiments, which should be considered in the scope of this specification. In addition, other implementations may be derived from the above-described embodiments, such that structural and logical substitutions and changes may be made without departing from the scope of the present disclosure.

The above embodiments illustrate merely some implementations of the present disclosure, which are described in details but are not construed to limit the scope of the present disclosure. It should be pointed that, for those skilled in the art, without departing from the principle of the present disclosure, various changes and improvements may be made, which are covered by the protection scope of the present disclosure. Therefore, the protection scope of the present disclosure is according to the appended claims.

What is claimed is:

1. A socket assembly, wherein the socket assembly is configured to be connected to utility power and an energy storage power supply and to externally supply power, the socket assembly comprising:
a utility power access terminal connected to the utility power via an electric wire;
a first connection terminal electrically connected to the utility power access terminal, wherein the energy storage power supply is configured to be in a pluggable connection with the first connection terminal to supply power to the energy storage power supply through the first connection terminal;
a second connection terminal configured to be in a pluggable connection with the energy storage power supply to receive electric energy from the energy storage power supply; and
an output terminal electrically connected to the second connection terminal and configured to supply power to a load, wherein the first connection terminal is disconnected from the output terminal; or when the energy storage power supply is connected to the second connection terminal, the first connection terminal is disconnected from the output terminal.

2. The socket assembly according to claim 1, further comprising:
a housing provided with a connection portion, wherein the housing is configured to be detachably mounted and fixed to an external main body through the connection portion.

3. The socket assembly according to claim 2, wherein the socket assembly is configured to be detachably mounted in a power distribution network,
wherein the power distribution network comprises a distribution box, the distribution box being provided with a plurality of branch switches, the utility power flowing to the load via the plurality of branch switches, and the socket assembly being mounted upstream or downstream of the plurality of branch switches.

4. The socket assembly according to claim 2, wherein the first connection terminal and/or the second connection terminal is detachably connected to the housing.

5. The socket assembly according to claim 4, wherein the housing comprises:
a first housing having a first opening and a second opening, wherein the first connection terminal is detachably mounted in the first opening, and wherein the second connection terminal is detachably mounted in the second opening; and
a second housing detachably coupled to the first housing, wherein the second housing and the first housing jointly define an accommodation cavity.

6. The socket assembly according to claim 2, wherein the utility power access terminal is disposed at an outer side wall of the housing and comprises:
a grounding terminal configured to be connected to a protective earth line of the utility power;
a live terminal configured to be connected to a phase line of the utility power; and
a neutral terminal configured to be connected to a neutral line of the utility power.

7. The socket assembly according to claim 1, wherein:
the first connection terminal comprises a first protection shell and a first power connection portion protruding relative to the first protection shell, wherein the first power connection portion is configured to be electrically connected to the utility power, such that the utility power can supply power to the energy storage power supply; and/or
the second connection terminal comprises a second protection shell and a second power connection portion protruding relative to the second protection shell, wherein the second power connection portion is configured to be electrically connected to each of the first power connection portion and the output terminal, to enable the utility power or the energy storage power supply to supply power to the load through the output terminal.

8. The socket assembly according to claim 1, wherein:
a path is disposed between the first connection terminal and the output terminal, and
a switch is disposed in the path, and configured to be opened when the energy storage power supply is connected to the second connection terminal.

9. The socket assembly according to claim 8, wherein:
the socket assembly further comprises a control device configured to obtain a connection state between the energy storage power supply and the second connection terminal, the control device being further configured to close the switch to conduct the path when the energy storage power supply is disconnected from the second connection terminal, and/or to open the switch to break the path when the energy storage power supply is connected to the second connection terminal; or
the switch is operable in response to the connection state between the energy storage power supply and the second connection terminal, wherein the switch is configured to be closed to conduct the path when the energy storage power supply is disconnected from the second connection terminal, and the switch is configured to be opened to break the path when the energy storage power supply is connected to the second connection terminal; or
the energy storage power supply comprises a triggering member, wherein the switch is configured to be closed to conduct the path when the energy storage power supply is disconnected from the second connection terminal; and wherein the triggering member abuts against the switch to break the path when the energy storage power supply is connected to the second connection terminal.

10. The socket assembly according to claim 1, further comprising:
a leakage protection circuit comprising a detection unit, a controller, and a connection switch, wherein:
the detection unit is configured to collect current signals of a phase line and a neutral line of the output terminal in real time, the controller being electrically connected to the detection unit;
the connection switch is disposed on each of the phase line and the neutral line of the output terminal; and
the controller is configured to control the connection switch to be opened in response to an abnormal signal collected by the detection unit.

11. The socket assembly according to claim 10, wherein the detection unit is disposed between the output terminal and the second connection terminal, and wherein the detection unit is configured to collect current signals of a phase line and a neutral line between the second connection terminal and the load in real time, the controller being electrically connected to the detection unit,
wherein the controller is configured to, in response to the signal collected by the detection unit, control the connection switch to be closed when no electric leakage occurs at the load, and control the connection switch to be opened when electric leakage occurs at the load.

12. The socket assembly according to claim 1, wherein one of the first connection terminal and the second connection terminal is configured as a wired connection port, the connection port being capable of being connected to the other one of the first connection terminal and the second connection terminal, to connect the first connection terminal to the second connection terminal.

13. The socket assembly according to claim 1, further comprising a jumper wire configured to connect the first connection terminal to the second connection terminal.

14. The socket assembly according to claim 13, having a first connection mode and a second connection mode, wherein:
in the first connection mode, the second connection terminal is in a pluggable electrical connection with the first connection terminal via the jumper wire; and
in the second connection mode, the socket assembly is connected to the energy storage power supply, the first connection terminal is electrically connected to a power input interface of the energy storage power supply, the second connection terminal is electrically connected to a power output interface of the energy storage power supply, the utility power supplies power to the load through the power input interface and the power output interface of the energy storage power supply, and the load is supplied with power by electric energy outputted by the energy storage power supply when the utility power fails.

15. The socket assembly according to claim 2, wherein the first connection terminal and the second connection terminal are disposed in the housing, wherein:
the housing has a first jack, and the first connection terminal comprises a metal member, the metal member being disposed corresponding to the first jack; and/or
the housing has a second jack, and the second connection terminal comprises a connection interface, the connection interface being disposed corresponding to the second jack.

16. An energy storage system, comprising:
an energy storage power supply configured to store and release electric energy; and
the socket assembly according to claim 1, wherein the energy storage power supply is electrically connected to each of the first connection terminal and the second connection terminal, the load being capable of being supplied, through the socket assembly, with power by the utility power or the energy storage power supply, the energy storage power supply being operable to supply power when the utility power is cut off.

17. The energy storage system according to claim 16, wherein the energy storage power supply comprises a power input interface configured to be electrically connected to the first connection terminal and a power output interface configured to be electrically connected to the second connection terminal.

18. The energy storage system according to claim 17, having a first operating mode and a second operating mode, wherein:
in the first operating mode, when utility power is connected or in an off-peak price state, the utility power charges the energy storage power supply and/or supplies power to the load through the energy storage power supply, the second connection terminal, and the output terminal; and
in the second operating mode, when the utility power is disconnected, or in a non-off-peak price state, the energy storage power supply supplies power to the load through the second connection terminal and the output terminal.

19. The energy storage system according to claim 18, wherein the energy storage power supply comprises a first switch, a second switch, an inverter, and a battery module, the power input interface being connected to the power output interface sequentially via the first switch and the second switch, wherein:
the inverter has an end connected between the first switch and the second switch and another end connected to the battery module,
in the first operating mode, both the first switch and the second switch are closed, and the inverter is in a rectification mode, to enable the inverter to charge the battery module using the utility power; and
in the second operating mode, the first switch is opened, the second switch is closed, and the inverter is in an inverter mode, to enable the electric energy of the battery module to be outputted to the second connection terminal through the inverter.

20. The energy storage system according to claim 16, having a third operating mode,
wherein in the third operating mode, in a case where the energy storage power supply is disconnected from each of the first connection terminal and the second connection terminal, the first connection terminal is connected to the second connection terminal through a jumper wire and the utility power is available, the utility power supplies power to the load through the socket assembly.
